(19) United States
(12) Patent Application Publication
(10) Pub. No.: US 2015/0317032 A1
(43) Pub. Date: Nov. 5, 2015

(54) METHOD FOR PERFORMING TOUCH COMMUNICATIONS CONTROL OF AN ELECTRONIC DEVICE, AND AN ASSOCIATED APPARATUS

(71) Applicant: MEDIATEK INC., Hsin-Chu (TW)

(72) Inventors: Szu-Wei Lin, Taipei City (TW); Tzu-Wen Chang, Taipei City (TW); Wan-Chun Liao, Taipei City (TW); Shang-Lun Ting, Taipei City (TW); Jing-Kuang Huang, Hsinchu City (TW)

(21) Appl. No.: 14/650,572

(22) PCT Filed: Nov. 14, 2014
(86) PCT No.: PCT/CN2014/091099

§ 371 Date: Jun. 9, 2015

Related U.S. Application Data
(60) Provisional application No. 61/904,496, filed on Nov. 15, 2013.
(60) Provisional application No. 61/907,597, filed on Nov. 22, 2013.
(60) Provisional application No. 61/910,135, filed on Nov. 29, 2013.

(51) Int. Cl. G06F 3/041; G06F 3/044

(52) U.S. Cl. CPC G06F 3/0418; G06F 3/0412; G06F 3/044; G06F 2203/04101; G06F 2203/04104; G06F 2203/04111; G06F 2203/04112

(57) ABSTRACT

A method for performing touch communications control and an associated apparatus are provided, where the method includes the steps of: performing communications to establish at least one communications connection between the touch communications device and a plurality of touch communications devices; obtaining identification information of each touch communications device of the plurality of touch communications devices to determine whether each touch communications device of the plurality of touch communications devices is one of a plurality of predetermined touch communications devices; and performing a predetermined action based on whether each touch communications device of the plurality of touch communications devices is one of the plurality of predetermined touch communications devices.

### CROSS REFERENCE TO RELATED APPLICATIONS

This application claims the benefit of U.S. Provisional Application No. 61/904,496, which was filed on Nov. 15, 2013, and is included herein by reference. In addition, this application claims the benefit of U.S. Provisional Application No. 61/907,597, which was filed on Nov. 22, 2013, and is included herein by reference. Additionally, this application claims the benefit of U.S. Provisional Application No. 61/910,135, which was filed on Nov. 29, 2013, and is included herein by reference.

### FIELD OF INVENTION

The present invention relates to touch communications technologies applied to electronic devices, and more particularly, to a method for performing touch communications control of an electronic device, and an associated apparatus.

### BACKGROUND OF THE INVENTION

According to the related art, Near Field Communication (NFC) can be regarded as a contactless identification and interaction technology, and can be used for performing short distance wireless communications between mobile devices, consumer electronic products, personal computers, and/or intelligent electronic devices through a method of near field magnetic coupling (e.g. using the frequency of 13.56 MHz). The users of NFC devices can intuitively exchange information and acquire contents and services with ease.

As the market for portable electronic devices such as mobile phones equipped with NFC functionalities has become mature, they can be used for supporting mobile payment or point of sale (POS). However, as the NFC devices are designed to transmit and receive signals through magnetic coupling, it is typical to implement an inductive card reader or some components having similar functionalities in the aforementioned portable electronic devices such as the mobile phones mentioned above, which may cause the sizes of the portable electronic devices to be increased, and further cause the layouts, the structure arrangement, and the materials of components in the portable electronic devices such as the mobile phones to be limited.

Therefore, some touch communications technologies regarding touch panel devices (e.g. electronic device equipped with touch panels), such as those described in the U.S. Patent Application Publication No. 2011/0304583, the U.S. Patent Application Publication No. US 2013/0147760, the China Patent Application Publication No. CN 102916729 A, are proposed recently, where the touch panels and the driving integrated circuit (IC) in the touch panel devices can be used for performing communications and data transmission. For example, a conventional touch panel device may comprise a touch sensor. In addition, at least one portion of the touch sensor can be at least one portion of the touch panel in the conventional touch panel device, where the touch panel can be a touch panel that does not have the display functionality (e.g. a touch pad), or a touch panel that has the display functionality (e.g. a touch screen). The touch sensor may comprise multiple driving electrodes and sensing electrodes installed on substrates, such as the driving electrodes and the sensing electrodes for forming capacitor structures. At least one of the driving electrodes and the sensing electrodes can be used as transmitting electrodes, and at least one of the driving electrodes and the sensing electrodes can be used as receiving electrodes. Thus, the signals can be transmitted or received by using the electrodes and the driving IC in the conventional touch panel device, to realize touch communications based on electric fields, having no need to implement any inductive card reader or some components having similar functionalities in the conventional touch panel device, where this architecture can significantly reduce the size and save the costs, in comparison with the NFC technology.

Please refer to FIG. 1, which illustrates a diagram of touch communications between a first touch panel device 101 and a second touch panel device 102 according to the related art. As shown in FIG. 1, there are near field electric fields 103a and 103b between the first touch panel device 101 and the second touch panel device 102. It should be noted that each of the first touch panel device 101 and the second touch panel device 102 can have the functionalities of transmitting and receiving signals. Based on this touch communications technology, when the first touch panel device 101 transmits signals toward the second touch panel device 102, the communications medium used by the first touch panel device 101 is the electric field portion whose electric field direction is pointing toward the second touch panel device 102 (e.g. the near electric field 103a shown in FIG. 1). In addition, when the second touch panel device 102 transmits signals toward the first touch panel device 101, the communications medium used by the second touch panel device 102 is the electric field portion whose electric field direction is pointing toward the first touch panel device 101 (e.g. the near electric field 103b shown in FIG. 1). Please note that the X channels and the Y channels shown in FIG. 1 may represent the transmitting electrodes and receiving electrodes installed on substrates, such as the transmitting electrodes and the receiving electrodes for forming capacitor structures.

FIG. 2 is a logical block diagram of a touch communications system for realizing the touch communications between the first touch panel device 101 and the second touch panel device 102 shown in FIG. 1 according to the related art, where the touch communications system may comprise a signal transmitting system 201 and a signal receiving system 202. The first touch panel device 101 shown in FIG. 1 may comprise the signal transmitting system 201 shown in FIG. 2, and the second touch panel device 102 shown in FIG. 1 may comprise the signal receiving system 202 shown in FIG. 2. The signal transmitting system 201 may comprise a touch communications request signal generating unit 211, a communications connection establishment unit 212, and a first communications unit 213. More particularly, the touch communications request signal generating unit 211 may be arranged to generate a touch communications request signal, and to transmit the touch communications request signal to the second touch panel device 102 through the transmitting electrodes of the first touch panel device 101. After the first touch panel device 101 receives a response signal responded by the second touch panel device 102, such as the response signal received through the receiving electrodes of the first touch panel device 101, the communications connection establishment unit 212 may establish a communications connection with the second touch panel device 102 (i.e. the communications connection between the first touch panel device 101 and the second touch panel device 102). After the communications connection establishment unit 212 establishes the communications connection, the first communications unit 213 may transmit communications information and/or data to the second touch panel device 102 through the transmitting electrodes of the first touch panel device 101.

The signal receiving system 202 may comprise a touch communications request signal responding unit 221, a communications connection establishment unit 222, and a second communications unit 223. More particularly, after receiving the touch communications request signal transmitted by the first touch panel device 101, such as the touch communications request signal received through the receiving electrodes of the second touch panel device 102, the touch communications request signal responding unit 221 may respond to the touch communications request signal with a response signal such as that mentioned above, and more particularly, may send the response signal to the first touch panel device 101 through the transmitting electrodes of the second touch panel device 102. After the touch communications request signal responding unit 221 responds to the touch communications request signal of the first touch panel device 101 with the response signal, the communications connection establishment unit 222 may establish the communications connection with the first touch panel device 101 (i.e. the communications connection between the first touch panel device 101 and the second touch panel device 102). After the communications connection establishment unit 222 establishes the communications connection, the second communications unit 223 may receive the communications information and/or data from the first touch panel device 101 through the receiving electrodes of the second touch panel device 102.

FIG. 3 illustrates a first touch panel 301 of the first touch panel device 101 shown in FIG. 1 and a second touch panel 302 of the second touch panel device 102 shown in FIG. 1 according to the related art. As shown in FIG. 3, each touch panel of the first touch panel 301 and the second touch panel 302 may comprise a touch sensor (not completely shown in FIG. 3). For example, the touch sensor of the first touch panel 301 may comprise a set of transmitting electrodes installed on at least one substrate of the first touch panel 301 (e.g. the transmitting electrode 311) for transmitting signals, and may comprise a set of receiving electrodes installed on at least one substrate of the first touch panel 301 (e.g. the receiving electrode 312) for receiving signals. In another example, the touch sensor of the second touch panel 302 may comprise a set of transmitting electrodes installed on at least one substrate of the second touch panel 302 (e.g. the transmitting electrode 321) for transmitting signals, and may comprise a set of receiving electrodes installed on at least one substrate of the second touch panel 302 (e.g. the receiving electrode 322) for receiving signals.

FIG. 4 is a flowchart of a touch communications method according to the related art. First, in Step S401, the touch communications request signal generating unit 211 of the first touch panel device 101 may generate a touch communications request signal such as that mentioned above, and transmit the touch communications request signal to the second touch panel device 102 through the transmitting electrode(s) of the first touch panel device 101. Afterward, in Step S402, the touch communications request signal responding unit 221 of the second touch panel device 102 may respond to the touch communications request signal with a response signal such as that mentioned above through the transmitting electrode(s) of the second touch panel device 102, and more particularly, send the response signal to the first touch panel device 101 through the transmitting electrode(s) of the second touch panel device 102. After the first touch panel device 101 receives the response signal responded by the second touch panel device 102, such as the response signal received through the receiving electrodes of the first touch panel device 101, in Step S403, the communications connection establishment unit 212 of the first touch panel device 101 and the communications connection establishment unit 222 of the second touch panel device 102 may establish a communications connection such as that mentioned above (i.e. the communications connection between the first touch panel device 101 and the second touch panel device 102). As a result, in Step S404, the first touch panel device 101 (more particularly, the first communications unit 213 therein) and the second touch panel device 102 (more particularly, the second communications unit 223 therein) may perform communications as shown in FIG. 4. For example, the first communications unit 213 of the first touch panel device 101 may transmit the communications information and/or data to the second touch panel device 102 through the transmitting electrodes of the first touch panel device 101, and the second communications unit 223 of the second touch panel device 102 may receive the communications information and/or data from the first touch panel device 101 through the receiving electrodes of the second touch panel device 102.

### SUMMARY OF THE INVENTION

It is an objective of the claimed invention to provide a method for performing touch communications control of an electronic device, and an associated apparatus, in order to enhance the overall performance.

It is another objective of the claimed invention to provide a method for performing touch communications control of an electronic device, and an associated apparatus, in order to improve the experience of the user.

According to at least one exemplary embodiment, a method for performing touch communications control is provided, where the method is applied to a touch communications device. The method comprises the steps of: performing communications to establish at least one communications connection between the touch communications device and a plurality of touch communications devices; obtaining identification information of each touch communications device of the plurality of touch communications devices to determine whether each touch communications device of the plurality of touch communications devices is one of a plurality of predetermined touch communications devices; and performing a predetermined action based on whether each touch communications device of the plurality of touch communications devices is one of the plurality of predetermined touch communications devices.

According to at least one exemplary embodiment, an apparatus for performing touch communications control is provided, where the apparatus comprises at least one portion (e.g. a portion or all) of an electronic device. The apparatus comprises a touch panel, and further comprises a processing circuit that is coupled to the touch panel. The touch panel is arranged to allow at least one communications connection to be established through the touch panel, and the processing circuit is arranged to perform touch communications control. More particularly, with aid of the touch panel, the processing circuit performs communications to establish at least one communications connection between the touch communications device and a plurality of touch communications devices, and obtains identification information of each touch communications device of the plurality of touch communications devices to determine whether each touch communications device of the plurality of touch communications devices is one of a plurality of predetermined touch communications devices. In addition, the processing circuit performs a predetermined action based on whether each touch communications device of the plurality of touch communications devices is one of the plurality of predetermined touch communications devices.

According to at least one exemplary embodiment, an electronic device comprising a sub-region is provided, wherein the sub-region comprises the apparatus for performing touch communications control mentioned above.

It is an advantage of the present invention that the present invention method and the associated apparatus can enhance the overall performance of touch communications devices. In addition, the present invention method and the associated apparatus can improve the experience of the user. Additionally, the security of the touch communications system implemented according to the present invention can be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of touch communications between a first touch panel device and a second touch panel device according to the related art.

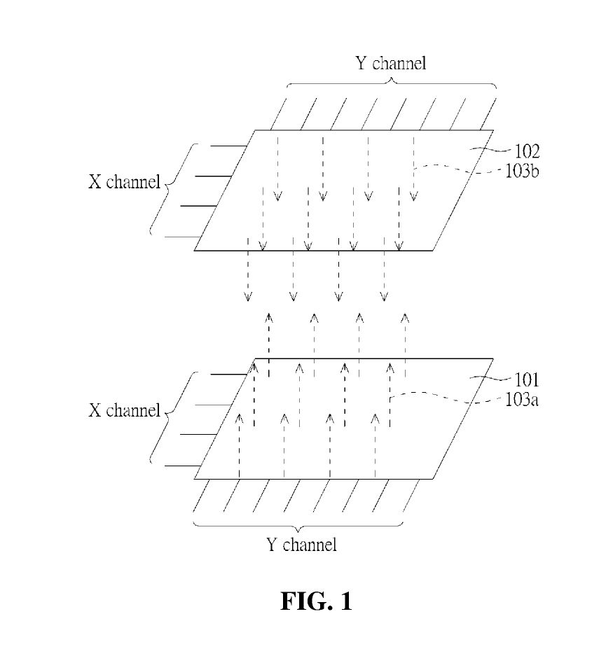

FIG. 2 is a logical block diagram of a touch communications system for realizing the touch communications between the first touch panel device and the second touch panel device shown in FIG. 1 according to the related art.

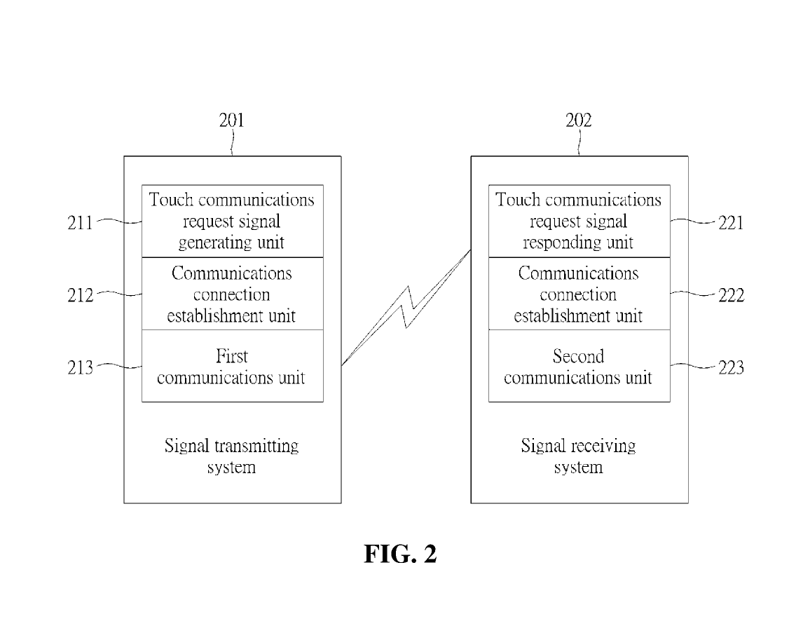

FIG. 3 illustrates a first touch panel of the first touch panel device shown in FIG. 1 and a second touch panel of the second touch panel device shown in FIG. 1 according to the related art.

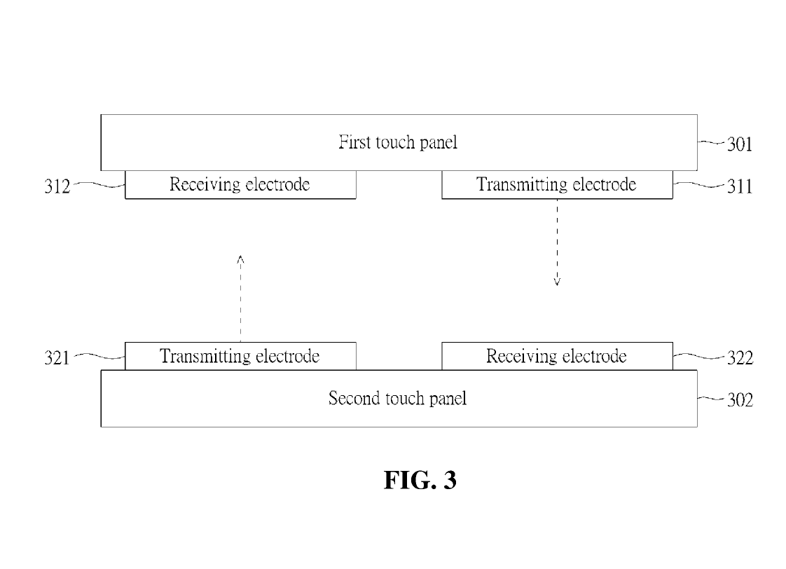

FIG. 4 is a flowchart of a touch communications method according to the related art.

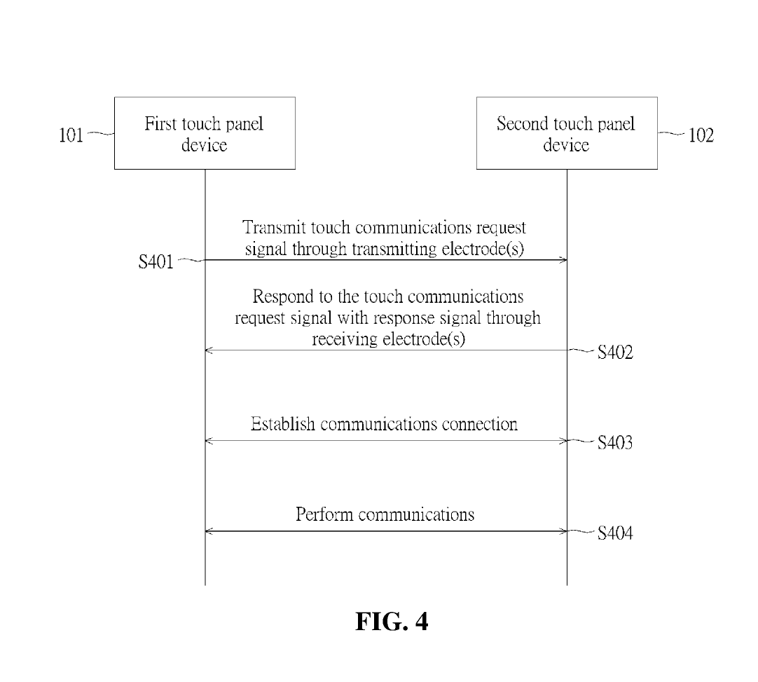

FIG. 5 is a diagram of an apparatus for performing touch communications control of an electronic device according to an exemplary embodiment of the present invention, where some associated electronic devices are illustrated for better comprehension.

FIG. 6 illustrates a flowchart of method for performing touch communications control of an electronic device according to an exemplary embodiment of the present invention.

FIG. 7 illustrates an action trigger control scheme involved with the method shown in FIG. 6 according to an exemplary embodiment of the present invention.

FIG. 8 illustrates a confirmation control scheme involved with the method shown in FIG. 6 according to another exemplary embodiment of the present invention.

FIG. 9 illustrates some implementation details of the confirmation control scheme shown in FIG. 8 according to an exemplary embodiment of the present invention.

FIG. 10 illustrates a strength division control scheme involved with the method shown in FIG. 6 according to an exemplary embodiment of the present invention.

FIG. 11 illustrates a time division control scheme involved with the method shown in FIG. 6 according to an exemplary embodiment of the present invention.

FIG. 12 illustrates some implementation details of the time division control scheme shown in FIG. 11 according to an exemplary embodiment of the present invention.

FIG. 13 illustrates a frequency division control scheme involved with the method shown in FIG. 6 according to an exemplary embodiment of the present invention.

FIG. 14 illustrates a code division control scheme involved with the method shown in FIG. 6 according to an exemplary embodiment of the present invention.

FIG. 15 is a diagram of a touch communications device according to an exemplary embodiment of the present invention, where the touch communications device of this exemplary embodiment may comprise at least one portion of one of the touch communications devices within the touch communications system shown in FIG. 5.

FIG. 16 illustrates two touch communications devices that are put to be close to each other according to an exemplary embodiment of the present invention, where at least one of the two touch communications devices of this exemplary embodiment can be the touch communications device shown in FIG. 15.

FIG. 17 illustrates a shape detection control scheme involved with the method shown in FIG. 6 according to an exemplary embodiment of the present invention.

FIG. 18 illustrates a signal sensing control scheme involved with the method shown in FIG. 6 according to an exemplary embodiment of the present invention.

FIG. 19 illustrates a shape detection control scheme involved with the method shown in FIG. 6 according to another exemplary embodiment of the present invention.

FIG. 20 illustrates a working flow involved with the method shown in FIG. 6 according to an exemplary embodiment of the present invention.

FIG. 21 illustrates a working flow involved with the method shown in FIG. 6 according to another exemplary embodiment of the present invention.

FIG. 22 illustrates an electronic device according to an exemplary embodiment of the present invention, where one of the two touch communications devices shown in FIG. 16 can be integrated into the electronic device, and the other one of the two touch communications devices shown in FIG. 16 may interact with the electronic device through the touch communications device that is integrated into the electronic device.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

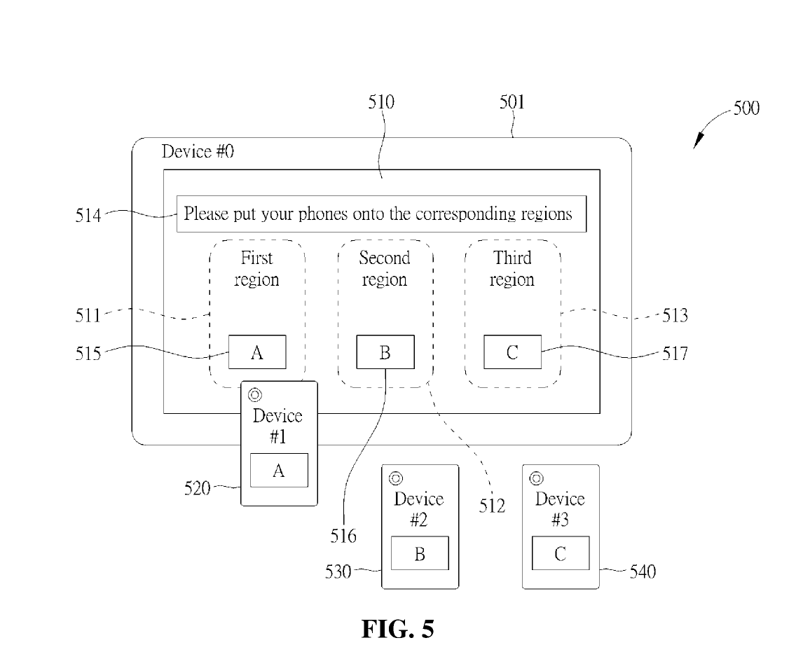

Please refer to FIG. 5, which illustrates a diagram of an apparatus for performing touch communications control of an electronic device according to an exemplary embodiment of the present invention, where some associated electronic devices (e.g. touch communications devices) are illustrated for better comprehension. As shown in FIG. 5, a touch communications system 500 may comprise multiple touch communications devices such as a touch communications device 501, a first touch communications device 520, a second touch communications device 530, and a third touch communications device 540 (respectively labeled “Device #0”, “Device #1”, “Device #2”, and “Device #3” in FIG. 5, for better comprehension), and the apparatus may comprise at least one portion (e.g. a portion or all) of this touch communications system 500, which can be implemented by using the touch communications technologies mentioned above. For example, the apparatus may comprise a portion of this touch communications system 500, such as the touch communications device 501. In another example, the apparatus may comprise a portion of this touch communications system 500, such as the first touch communications device 520. In another example, the apparatus may comprise a portion of this touch communications system 500, such as the second touch communications device 530. In another example, the apparatus may comprise a portion of this touch communications system 500, such as the third touch communications device 540. In another example, the apparatus may comprise the whole of this touch communications system 500. This is for illustrative purposes only, and is not meant to be a limitation of the present invention. According to some variations of this exemplary embodiment, the apparatus may comprise at least one circuit of a specific touch communications device within the touch communications device 501, the first touch communications device 520, the second touch communications device 530, and the third touch communications device 540, such as at least one integrated circuit (IC) within one of the touch communications device 501, the first touch communications device 520, the second touch communications device 530, and the third touch communications device 540.

In this exemplary embodiment, each of the touch communications device 501, the first touch communications device 520, the second touch communications device 530, and the third touch communications device 540 can be implemented by using the touch communications technologies mentioned above, and more particularly, can be a touch panel device that is capable of performing the operations of at least one of the first touch panel device 101 and the second touch panel device 102 mentioned above. In addition, each of the touch communications devices 501, 520, 530 and 540 can be equipped with a processing circuit (not shown in FIG. 5) for performing touch communications control, where the processing circuit may run some program codes to control the associated operations of touch communications control.

The touch communications device 501 is capable of detecting the contact or approaching of another touch communications device with aid of the touch communications technologies mentioned above. In some exemplary embodiments, the touch communications device 501 is further capable of detecting location of another touch communications device. As shown in FIG. 5, under control of the processing circuit of the touch communications device 501, the touch panel 510 of the touch communications device 501 (more particularly, a touch-sensitive display module of the touch communications device 501 in this exemplary embodiment, such as a touch screen) may display notification information 514 (e.g. the string “Please put your phones onto the corresponding regions”, for example), which can be regarded as a hint, to guide one or more users to place the first touch communications device 520, the second touch communications device 530, and the third touch communications device 540 to be close to, or in contact with, the first region 511, the second region 512, and the third region 513 of the touch panel 510, respectively. In addition, under control of the processing circuit of the touch communications device 501, the touch panel 510 may display first device information 515, second device information 516, and third device information 517.

In this exemplary embodiment, the device information 515, 516 and 517 can be used for notifying the aforementioned one or more users of which touch communications device should be put onto (or put close to) one of the regions 511, 512 and 513. For example, the aforementioned one or more users may comprise a user A, a user B, and a user C. In a situation where the first touch communications device 520 belongs to the user A, the first device information 515 may comprise the name of the user A (e.g. the name “A”), and therefore can be used for guiding the user A to place the first touch communications device 520 (which may have the corresponding tag with the name “A” thereon, for example) to be close to, or in contact with, the first region 511. In addition, in a situation where the second touch communications device 530 belongs to the user B, the second device information 516 may comprise the name of the user B (e.g. the name “B”), and therefore can be used for guiding the user B to place the second touch communications device 530 (which may have the corresponding tag with the name “B” thereon, for example) to be close to, or in contact with, the second region 512. Additionally, in a situation where the third touch communications device 540 belongs to the user C, the third device information 517 may comprise the name of the user C (e.g. the name “C”), and therefore can be used for guiding the user C to place the third touch communications device 540 (which may have the corresponding tag with the name “C” thereon, for example) to be close to, or in contact with, the third region 513. This is for illustrative purposes only, and is not meant to be a limitation of the present invention. According to some variations of this exemplary embodiment, the device information mentioned above, such as the device information 515, 516 and 517, may vary. For example, the device information (e.g. the first device information 515) may comprise product information of corresponding touch communications device (e.g. the first touch communications device 520) or any other information capable of hinting which touch communications device to put onto/close to such as the brand name and/or the model number of the corresponding touch communications device, and therefore can be used for guiding the user to place the corresponding touch communications device to be close to, or in contact with, the corresponding region (e.g. the first region 511).

As mentioned above, under control of the aforementioned processing circuit of the touch communications device 501, the touch panel 510 of the touch communications device 501 may display the device information 515, 516 and 517 for notifying the aforementioned one or more users of which touch communications device should be put onto (or put close to) one of the regions 511, 512 and 513. This is for illustrative purposes only, and is not meant to be a limitation of the present invention. According to some variations of this exemplary embodiment, the device information 515, 516 and 517 may not be displayed while the real owners of the touch communications devices 520, 530 and 540 may be the only people that knows which of the regions 511, 512 and 513 is the correct region for the specific user to place his/her own touch communications device to be close to, or in contact with. Thus, in a situation where the processing circuit of the touch communications device 501 prevents the touch panel 510 from displaying the device information 515, 516 and 517, the security of the touch communications system 500 can be enhanced.

In this exemplary embodiment, communications connection can be established between the touch communications device 501 and any of the touch communications devices 520, 530 and 540 that is close to or in contact with the touch communications device 501. The communications connection can be established via the touch panel 501. For example, when the touch communications device 520 is close to or in contact with the touch communications device 501, a communications connection between the touch communications devices 520 and 501 can be established via the touch panel 501; when the touch communications device 530 is close to or in contact with the touch communications device 501, a communications connection between the touch communications devices 530 and 501 can be established via the touch panel 501; when the touch communications device 540 is close to or in contact with the touch communications device 501, a communications connection between the touch communications devices 540 and 501 can be established via the touch panel 501.

In this exemplary embodiment, the processing circuit of the touch communications device 501 may obtain identification information of the touch communications devices 520, 530 and 540 to determine whether each of the touch communications devices 520, 530 and 540 is one of a plurality of predetermined touch communications devices. For example, the processing circuit of the touch communications device 501 may obtain identification information to determine whether each of the touch communications devices 520, 530 and 540 is indeed one of the plurality of predetermined touch communications devices that belong to users A, B and C. The identification information may be obtained through the communications connection(s) between the touch communications device 501 and the touch communications devices 520, 530 and 540. In one exemplary embodiment, not each of the touch communications devices 520, 530 and 540 has communications connection with the touch communications device 501, for example, the device 530 may be the only one having communications connection with the device 501. Then the device 501 may obtain the identification information of the devices 520, 530 and 540 through the communications connection between the device 501 and the device 530. The touch communications devices 520, 530 and 540 may generate and send a first device identification information, a second device identification information, and a third device identification information to the touch communications device 501 to allow the touch communications device 501 to identify (or recognize) the first touch communications device 520, the second touch communications device 530, and the third touch communications device 540, respectively. For example, according to an exemplary embodiment of the present invention, the first device identification information, the second device identification information, and the third device identification information can be received by the first region 511, the second region 512, and the third region 513 of the touch panel 510, respectively. This is for illustrative purposes only, and is not meant to be a limitation of the present invention. According to some variations of this exemplary embodiment, the device identification information can be received by any other region of the touch panel 510, such as at least one other region (e.g. one or more other regions) of the touch panel 510. In this exemplary embodiment, each of the first device identification information, the second device identification information, and the third device identification information can be identification information that can be used for identifying the corresponding touch communications device within the touch communications devices 520, 530 and 540, where examples of the identification information may include, but not limited to, the user name, the International Mobile Equipment Identity (IMEI) number, certification information, authorization information, etc.

In one exemplary embodiment, the processing circuit of the touch communications device 501 may perform a predetermined action based on whether each of the touch communications devices 520, 530 and 540 is one of the plurality of predetermined touch communications devices. For example, in a situation where each of the touch communications devices 520, 530 and 540 is one of the plurality of predetermined touch communications devices that belongs to users A, B and C, the aforementioned processing circuit of the touch communications device 501 can perform a predetermined action such as control another electronic device, start running at least one application (e.g. one or more applications) corresponding to this situation, etc. The predetermined action can be associated with the touch communications devices 520, 530 and 540. Examples of controlling another electronic device may include, but not limited to, opening an electronic safe deposit box, operating a machine that can only be operated with authorization, etc. Examples of the aforementioned at least one application may include, but not limited to, encrypted document browsing applications, joint account management applications, etc., which may depend on various kinds of market requirements. In one exemplary embodiment, the processing circuit of the touch communications device 501 may perform the predetermined action only based on whether each of the touch communications devices 520, 530 and 540 is one of the plurality of predetermined touch communications devices. Thus in this exemplary embodiment, the predetermined action may be performed as long as the identification information of all of the touch communications devices 520, 530 and 540 can be obtained and all of the touch communications devices 520, 530 and 540 are determined to be one of the plurality of predetermined touch communications devices. Then in this exemplary embodiment, the touch panel 510 may not display information capable of hinting which touch communications device to put onto/close to the touch communications device 501. Further in this exemplary embodiment, not each of the touch communications devices 520, 530 and 540 may be required to have communications connection with the touch communications device 501 since the identification information of all the devices 520, 530 and 540 may be obtained through even only one communications connection between device 501 and one of the devices 520, 530 and 540.

According to one exemplary embodiment, in a situation where each of the touch communications devices 520, 530 and 540 is one of the plurality of predetermined touch communications devices and is in contact with or close to the touch communications device 501, the predetermined action can be performed when this situation has not been changed for a predetermined time period. The predetermined time period can be set as three seconds, for example, or any other length of time according to different design requirements. In the aforementioned situation of these exemplary embodiments, within three seconds, if any of the touch communications devices 520, 530 and 540 (e.g. one or more of the devices 520, 530 and 540) is removed from the touch communications device 501, the processing circuit of the touch communications device 501 may determine that the condition for performing the predetermined action (e.g. running an application associated with the devices 520, 530 and 540) is not satisfied. Thus, the touch communications devices 520, 530 and 540 may have to be close to, or in contact with, the touch communications device 501 for the predetermined time period such as three seconds again to make the condition for performing the predetermined action be satisfied, so the processing circuit of the touch communications device 501 may perform the predetermined action. This is for illustrative purposes only, and is not meant to be a limitation of the present invention. According to some variations of this exemplary embodiment, the condition for performing the predetermined action may vary. For example, if any of the touch communications devices 520, 530 and 540 is removed from touch communications device 501, the processing circuit of the touch communications device 501 may determine that the condition for performing the predetermined action is not satisfied and does not allow the devices 520, 530 and 540 to try again.

According to the exemplary embodiments, the predetermined time period mentioned above can be set as three seconds. This is for illustrative purposes only, and is not meant to be a limitation of the present invention. According to at least one other exemplary embodiment, the predetermined time period mentioned above can be set to be equivalent to another fixed value of time.

The aforementioned apparatus for performing touch communications control (i.e. the apparatus which may comprise the at least one portion of the touch communications system 500 shown in FIG. 5) can be applied to security systems or other systems that are related to safety issues. For example, some applications such as the aforementioned at least one application may run when the conditions for running these applications are satisfied, respectively, where a plurality of users such as the user A, the user B, and the user C should cooperate to trigger running any of these applications. In addition, before successfully triggering running an application, any of the plurality of users may cancel the current action (e.g. triggering running this application) by taking or moving away the touch communications device that he/she is holding. Thus, when any of the plurality of users finds that the current action (e.g. triggering running this application) may be improper, they may have a chance to discuss further.

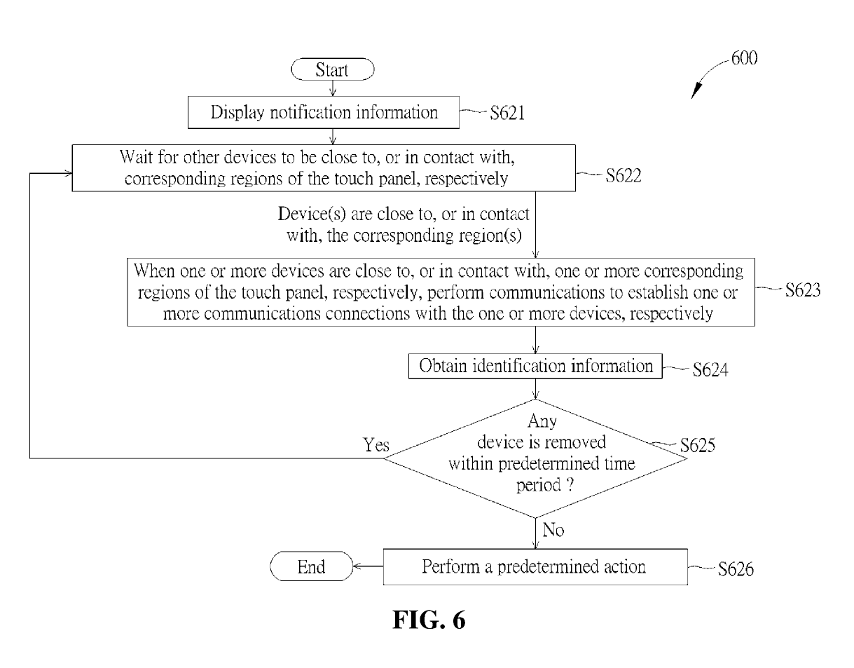

FIG. 6 illustrates a flowchart of method 600 for performing touch communications control of an electronic device such as that mentioned above according to an exemplary embodiment of the present invention. The method 600 can be applied to the aforementioned apparatus for performing touch communications control (i.e. the apparatus which may comprise the aforementioned at least one portion of the touch communications system 500 shown in FIG. 5), and more particularly, can be applied to the touch communications device 501 and the processing circuit thereof. The method 600 can be described as follows.

In Step S621, under control of the processing circuit of the touch communications device 501 (more particularly, the processing circuit running the program codes mentioned above), the touch panel 510 of the touch communications device 501 (more particularly, the aforementioned touch-sensitive display module of the exemplary embodiment shown in FIG. 5, such as the touch screen mentioned above) displays the notification information 514, which can be regarded as a hint, to guide the aforementioned one or more users such as the user A, the user B, and the user C to place the first touch communications device 520, the second touch communications device 530, and the third touch communications device 540 to be close to, or in contact with, the first region 511, the second region 512, and the third region 513 of the touch panel 510, respectively.

In Step S622, the touch communications device 501 (more particularly, the processing circuit thereof) may wait for the first touch communications device 520, the second touch communications device 530, and the third touch communications device 540 to be close to, or in contact with, the first region 511, the second region 512, and the third region 513 of the touch panel 510, respectively.

In Step S623, under control of the processing circuit of the touch communications device 501, when one or more touch communications devices of the first touch communications device 520, the second touch communications device 530, and the third touch communications device 540 is close to, or in contact with, the corresponding region(s) of the touch panel 510 (e.g. one or more regions corresponding to the aforementioned one or more touch communications devices within the first region 511, the second region 512, and the third region 513), the touch communications device 501 performs communications to establish one or more communications connections with the aforementioned one or more touch communications devices, respectively.

For example, under control of the processing circuit of the touch communications device 501, when it is detected that any touch communications device within the aforementioned one or more touch communications devices is removed (or taken away) from the touch communications device 501, the touch communications device 501 may disconnect the communications connection between the touch communications device 501 and the removed touch communications device, i.e. the touch communications device that is removed (or taken away) from the touch communications device 501. This is for illustrative purposes only, and is not meant to be a limitation of the present invention.

In Step S624, under control of the processing circuit of the touch communications device 501, the device 501 obtains the identification information of the aforementioned one or more touch communications devices of Step S623.

In Step S625, after the touch communications device 501 performs communications to establish the communications connection(s) between the touch communications device 501 and one or more of the first touch communications device 520, the second touch communications device 530, and the third touch communications device 540 that are close to or in contact with the device 501, the processing circuit of the touch communications device 501 checks whether any of the devices 520, 530 and 540 that has been connected with the device 501 is removed (or taken away) from the touch communications device 501 within a predetermined time period such as that mentioned above. When it is detected that any of the devices 520, 530 and 540 is removed (or taken away) from the touch communications device 501 within the predetermined time period, Step S622 is re-entered; otherwise, Step S626 is entered.

In Step S626, the processing circuit of the touch communications device 501 performs a predetermined action. For example, the processing circuit of the touch communications device 501 may run the corresponding application such as the aforementioned at least one application (e.g. the associated application that is supposedly to be run in the situation mentioned in some of the above exemplary embodiments).

As shown in FIG. 6, the operation of Step S624 may be performed before the operation of Step S625. This is for illustrative purposes only, and is not meant to be a limitation of the present invention. According to some embodiments of the present invention, the operation of Step S624 may be performed after the operation of Step S625. According to some embodiments of the present invention, the operation of Step S625 may be omitted.

As mentioned above, the processing circuit of the touch communications device 501 may check whether any of the touch communications devices 520, 530 and 540 is removed (or taken away) from the touch communications device 501 within the predetermined time period. This is for illustrative purposes only, and is not meant to be a limitation of the present invention. In another example, after the touch communications device 501 performs communications to establish the communications connections between the touch communications device 501 and all of the touch communications devices 520, 530 and 540, respectively, the processing circuit of the touch communications device 501 may check whether the communications connection between the touch communications device 501 and each of the touch communications devices 520, 530 and 540 has been established for the predetermined time period mentioned above.

Please note that the associated operations of the method 600 have been disclosed in the above exemplary embodiments. For brevity, similar descriptions for this exemplary embodiment are not repeated in detail here.

According to some exemplary embodiments, the aforementioned apparatus for performing touch communications control may comprises at least one portion (e.g. a portion or all) of an electronic device such as the touch communications device 501. More particularly, this apparatus may comprise a touch panel such as the touch panel 510, and may further comprise a processing circuit that is coupled to the touch panel, where the processing circuit may comprise the processing circuit of the touch communications device 501, such as the processing circuit running the program codes mentioned above. The touch panel can be arranged to allow at least one communications connection to be established through the touch panel, and the processing circuit can be arranged to perform touch communications control. In addition, with aid of the touch panel, the processing circuit may perform communications to establish at least one communications connection between the touch communications device and a plurality of touch communications devices (e.g. the touch communications devices 520, 530 and 540), and obtains identification information of each touch communications device of the plurality of touch communications devices to determine whether each touch communications device of the plurality of touch communications devices is one of a plurality of predetermined touch communications devices. Additionally, the processing circuit may perform a predetermined action based on whether each touch communications device of the plurality of touch communications devices is one of the plurality of predetermined touch communications devices.

In some exemplary embodiments, the processing circuit may obtain the identification information according to different methods. For example, the processing circuit may obtain the identification information of a specific touch communications device of the plurality of touch communications devices through the communications connection between the touch communications device and the specific touch communications device, and the processing circuit may determine whether the specific touch communications device is one of the plurality of predetermined touch communications devices according to the identification information of the specific touch communications device. In another example, the processing circuit may obtain the identification information of a specific touch communications device of the plurality of touch communications devices by performing shape detection on the specific touch communications device. More particularly, the identification information of the specific touch communications device may be a detection result indicating whether an outline of the specific touch communications device matches a predetermined outline. In particular, the processing circuit may detect whether a shape and a size of the outline of the specific touch communications device match that of the predetermined outline, respectively, to obtain the identification information of the specific touch communications device.

In some exemplary embodiments, the processing circuit may trigger the predetermined action according to different methods. For example, when it is detected that each touch communications device of the plurality of touch communications devices is one of the plurality of predetermined touch communications devices, the processing circuit may immediately perform the predetermined action associated with the plurality of touch communications devices. In another example, when it is detected that each touch communications device of the plurality of touch communications devices is one of the plurality of predetermined touch communications devices, the processing circuit may wait for a predetermined time period and check whether the communications connection between the touch communications device and any touch communications device of the plurality of touch communications devices is broken. When it is detected that the communications connection between the touch communications device and any touch communications device of the plurality of touch communications devices is not broken during the predetermined time period, the processing circuit may perform the predetermined action associated with the plurality of touch communications devices.

In some exemplary embodiments, the touch communications device and the plurality of touch communications devices can be implemented with touch communications technologies. For example, before the communications connection between the touch communications device and a specific touch communications device of the plurality of touch communications devices is established, a distance between a touch panel of the specific touch communications device and the touch panel of the touch communications device is not larger than a predetermined length.

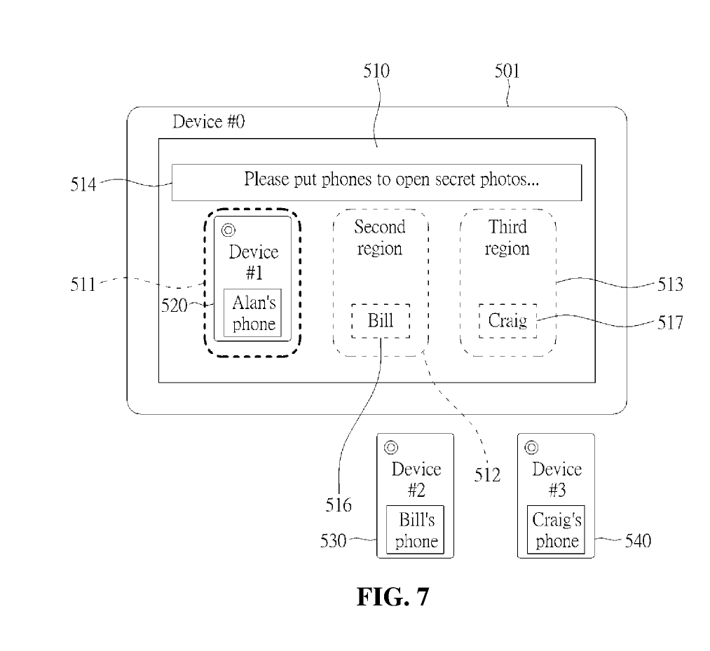

FIG. 7 illustrates an action trigger control scheme involved with the method 600 shown in FIG. 6 according to an exemplary embodiment of the present invention. In this exemplary embodiment, the notification information 514, which can be regarded as a hint, may comprise a message such as “Please put phones to open secret photos . . . ”, for example. In addition, the user A, the user B, and the user C of this exemplary embodiment can be Alan, Bill, and Craig, respectively, and therefore, the first device information 515, the second device information 516, and the third device information 517 of this exemplary embodiment can be their names (e.g. “Alan”, “Bill”, and “Craig”), respectively. Additionally, under control of the aforementioned processing circuit of the touch communications device 501, the touch panel 510 of the touch communications device 501 may display the boundaries of the first region 511, the second region 512, and the third region 513 with a specific type of dashed lines (e.g. thin dashed lines in this exemplary embodiment).

For better comprehension, the first touch communications device 520, the second touch communications device 530, and the third touch communications device 540 of this exemplary embodiment may have the corresponding tags with the strings “Alan's Phone”, “Bill's Phone”, and “Craig's Phone” thereon, respectively. For example, when a specific user within the users A, B and C, such as Alan in this exemplary embodiment, puts his phone (i.e. the first touch communications device 520 in this exemplary embodiment) close to or in contact with the corresponding region of the touch panel 510, such as the first region 511 corresponding to the first touch communications device 520 in this exemplary embodiment, the communications connection between the touch communications device 501 and the first touch communications device 520 can be established. Under control of the processing circuit of the touch communications device 501, the touch panel 510 may display the boundary of the first region 511 with another type of dashed lines, to indicate that the communications connection between the touch communications device 501 and the first touch communications device 520 has been established. For brevity, similar descriptions for this exemplary embodiment are not repeated in detail here.

Please note that, in the embodiment shown in FIG. 7, the operation of obtaining the identification information of the aforementioned one or more touch communications devices may be performed before the operation of checking whether any touch communications device is removed (or taken away) from the touch communications device 501 within the predetermined time period. This is for illustrative purposes only, and is not meant to be a limitation of the present invention. According to some embodiments of the present invention, the operation of obtaining the identification information of the aforementioned one or more touch communications devices may be performed after the operation of checking whether any touch communications device is removed (or taken away) from the device 501 within the predetermined time period. According to some embodiments of the present invention, the operation of checking whether any touch communications device is removed (or taken away) from the device 501 within the predetermined time period may be omitted.

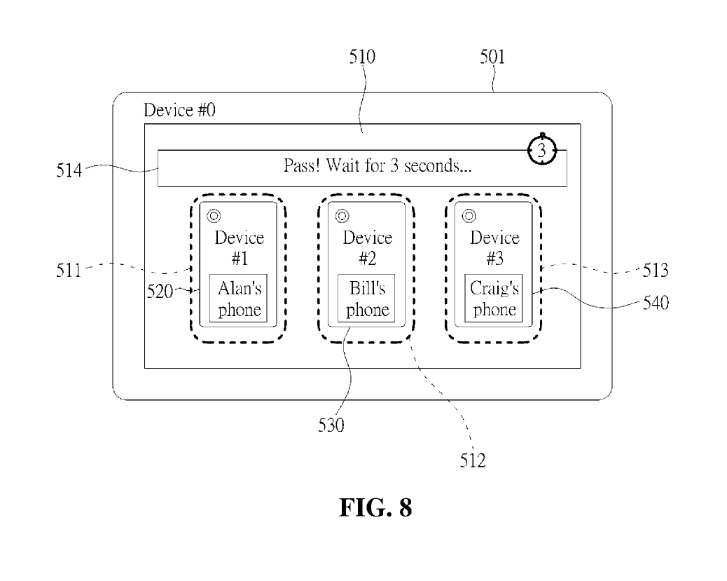

FIG. 8 illustrates a confirmation control scheme involved with the method 600 shown in FIG. 6 according to another exemplary embodiment of the present invention. In this exemplary embodiment, the notification information 514, which can be regarded as a hint, may comprise a message such as “Pass! Wait for 3 seconds . . . ”, for example. Similarly, the user A, the user B, and the user C of this exemplary embodiment can be Alan, Bill, and Craig, respectively, and the first touch communications device 520, the second touch communications device 530, and the third touch communications device 540 of this exemplary embodiment may have the corresponding tags with the strings “Alan's Phone”, “Bill's Phone”, and “Craig's Phone” thereon, respectively.

For example, when all of the users A, B and C, such as Alan, Bill, and Craig in this exemplary embodiment, have put their phone (i.e. the touch communications devices 520, 530 and 540 in this exemplary embodiment) close to or in contact with the corresponding regions of the touch panel 510, such as the regions 511, 512 and 513, the communications connection between the touch communications device 501 and each of the touch communications devices 520, 530 and 540 may have been established. Under control of the processing circuit of the touch communications device 501, the touch panel 510 may display the boundaries of the regions 511, 512 and 513 with the other type of dashed lines, to indicate that the communications connection between the touch communications device 501 and each of the touch communications devices 520, 530 and 540 has been established. In addition, the notification information 514 of this exemplary embodiment may comprise a time-related icon such as the stop watch illustrated around the upper right corner of FIG. 8, where the time-related icon is typically labeled with the remaining time that the users should wait for.

As mentioned above, the predetermined time period can be set as three seconds, for example. Thus, when all of the users A, B and C have put their phone close to or in contact with the corresponding regions of the touch panel 510, such as the regions 511, 512 and 513, and the communications connections between the touch communications device 501 and each of the touch communications devices 520, 530 and 540 have just been established, the remaining time that the users should wait for is equivalent to the predetermined time period such as three seconds (labeled “3” in FIG. 8, for better comprehension) at this moment. For brevity, similar descriptions for this exemplary embodiment are not repeated in detail here.

Please note that, in the embodiment shown in FIG. 8, the operation of obtaining the identification information of the aforementioned one or more touch communications devices may be performed before the operation of checking whether any touch communications device is removed (or taken away) from the touch communications device 501 within the predetermined time period. This is for illustrative purposes only, and is not meant to be a limitation of the present invention. According to some embodiments of the present invention, the operation of obtaining the identification information of the aforementioned one or more touch communications devices may be performed after the operation of checking whether any touch communications device is removed (or taken away) from the device 501 within the predetermined time period. According to some embodiments of the present invention, the operation of checking whether any touch communications device is removed (or taken away) from the device 501 within the predetermined time period may be omitted.

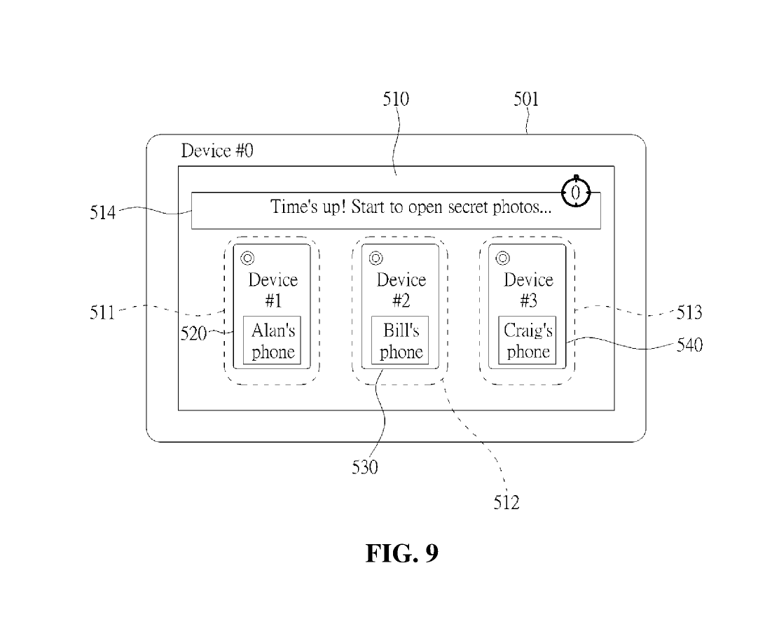

FIG. 9 illustrates some implementation details of the confirmation control scheme shown in FIG. 8 according to an exemplary embodiment of the present invention. In this exemplary embodiment, the notification information 514, which can be regarded as a hint, may comprise a message related to the action about to be performed such as “Time's up! Start to open secret photos . . . ”, for example. This is for illustrative purpose only, but not meant to be a limitation. Similarly, the users A, B and C of this exemplary embodiment can be Alan, Bill, and Craig, respectively, and the touch communications devices 520, 530 and 540 of this exemplary embodiment may have the corresponding tags with the strings “Alan's Phone”, “Bill's Phone”, and “Craig's Phone” thereon, respectively. In addition, the notification information 514 of this exemplary embodiment may comprise the aforementioned time-related icon such as the stop watch illustrated around the upper right corner of FIG. 9, where the time-related icon is typically labeled with the remaining time that the users should wait for.

For example, suppose that none of the touch communications devices 520, 530 and 540 is removed from the touch communications device 501 during the predetermined time period. When all of the users A, B and C in this exemplary embodiment have waited for the predetermined time period (e.g. three seconds in this exemplary embodiment), the remaining time that the users should wait for is equivalent to zero (labeled “0” in FIG. 9, for better comprehension) at this moment. And then a predetermined action can be performed. For brevity, similar descriptions for this exemplary embodiment are not repeated in detail here.

Please note that, in the embodiment shown in FIG. 9, the operation of obtaining the identification information of the aforementioned one or more touch communications devices may be performed before the operation of checking whether any touch communications device is removed (or taken away) from the touch communications device 501 within the predetermined time period. This is for illustrative purposes only, and is not meant to be a limitation of the present invention. According to some embodiments of the present invention, the operation of obtaining the identification information of the aforementioned one or more touch communications devices may be performed after the operation of checking whether any touch communications device is removed (or taken away) from the device 501 within the predetermined time period. According to some embodiments of the present invention, the operation of checking whether any touch communications device is removed (or taken away) from the device 501 within the predetermined time period may be omitted.

In any of the embodiments respectively shown in FIGS. 5-9, the touch communications devices 520, 530 and 540 may be taken as an example for descriptions. This is for illustrative purposes only, and is not meant to be a limitation of the present invention. According to some embodiments of the present invention, the number NDEV of touch communications devices being placed to be close to, or in contract with, the touch communications device 501 may vary. For example, the number NDEV may be equal to one. In another example, the number NDEV may be greater than one. According to some embodiments of the present invention, the number NDEV may be different from the number NUSER of users, where the number NDEV may be greater than the number NUSER. According to some embodiments of the present invention, the number NDEV may be different from the number NID of sets (or pieces) of identification information, where the number NDEV may be less than the number NID.

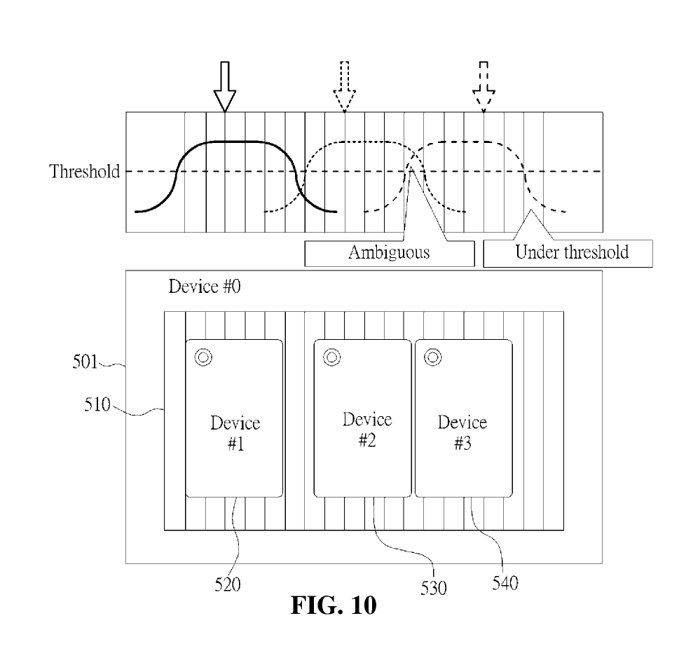

FIG. 10 illustrates a strength division control scheme involved with the method 600 shown in FIG. 6 according to an exemplary embodiment of the present invention. For example, the touch panel 510 of the touch communications device 501 (more particularly, the aforementioned touch-sensitive display module of the exemplary embodiment shown in FIG. 5, such as the touch screen mentioned above) may comprise a plurality of electrodes, and the processing circuit of the touch communications device 501 (more particularly, the processing circuit running the program codes mentioned above) may use different electrodes within the plurality of electrodes to connect multiple client devices such as the first touch communications device 520, the second touch communications device 530, and the third touch communications device 540, respectively, with the aid of the touch communications technologies mentioned above.

For better comprehension, the touch communications device 501, the first touch communications device 520, the second touch communications device 530, and the third touch communications device 540 of this exemplary embodiment can be labeled “Device #0”, “Device #1”, “Device #2”, and “Device #3”, respectively. According to this exemplary embodiment, the processing circuit of the touch communications device 501 may check each electrode of the plurality of electrodes to find out which client(s) of the client devices (e.g. one or more touch communications devices within the touch communications devices 520, 530 and 540) is/are connected. As shown in FIG. 10, for example, when all of the touch communications devices 520, 530 and 540 are in contact with or close to the touch panel 510 of the touch communications device 501, the processing circuit of the touch communications device 501 may check the output signals of the plurality of electrodes to determine the locations of the touch communications devices 520, 530 and 540, where the curves shown in the upper half of FIG. 10 may represent the signal components respectively corresponding to the touch communications devices 520, 530 and 540 within the output signals of the plurality of electrodes.

In this exemplary embodiment, the processing circuit of the touch communications device 501 may ignore an output signal within the output signals of the plurality of electrodes that has a signal strength less than a predetermined threshold. For example, the predetermined threshold can be illustrated with the dashed line in the upper half of FIG. 10. In addition, the processing circuit of the touch communications device 501 may ignore ambiguous signals, which may occur in a situation where two devices are put close to each other. For example, the second touch communications device 530 and the third touch communications device 540 (respectively “Device #2” and “Device #3” in FIG. 10, for brevity) may be put close to each other, where ambiguous signals may be outputted from some electrodes near the gap between the devices 530 and 540. Additionally, when there are several signals transmitted from one of the touch communications devices 520, 530 and 540 and received by the electrodes mentioned above, the processing circuit of the touch communications device 501 may perform communications to establish connection with the device via the electrode that receives the signal of best strength among the several signals. For brevity, similar descriptions for this exemplary embodiment are not repeated in detail here.

In the exemplary embodiment shown in FIG. 10, for better comprehension, the electrodes corresponding to one dimension, such as the vertical lines within the touch panel 510 shown in FIG. 10, are illustrated. This is for illustrative purposes only, and is not meant to be a limitation of the present invention. According to some variations of this exemplary embodiment, the electrodes corresponding to another dimension can be illustrated.

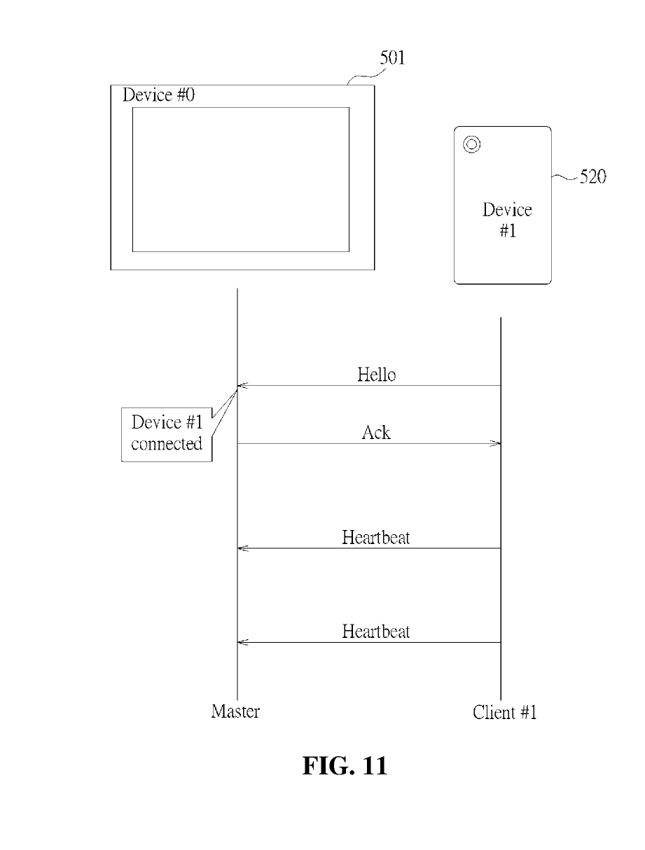

FIG. 11 illustrates a time division control scheme involved with the method 600 shown in FIG. 6 according to an exemplary embodiment of the present invention. Please note that the touch communications device 501 of this exemplary embodiment can be regarded as the master device (labeled “Master” in FIG. 11, for brevity), where the first touch communications device 520 of this exemplary embodiment can be regarded as the client device (labeled “Client #1” in FIG. 11, for brevity).

According to this exemplary embodiment, the processing circuit of the touch communications device 501 may interact with any of the first touch communications device 520, the second touch communications device 530, and the third touch communications device 540, such as the first touch communications device 520 in this exemplary embodiment. For example, under control of the processing circuit of the first touch communications device 520, the first touch communications device 520 may send a signal labeled “Hello” shown in FIG. 11. Under control of the processing circuit of the touch communications device 501, the touch communications device 501 may perform communications to establish the communications connection between the touch communications device 501 and the first touch communications device 520.

In this exemplary embodiment, under control of the processing circuit of the touch communications device 501, the touch communications device 501 may send an acknowledgement (Ack) to the first touch communications device 520 in response to the signal “Hello” shown in FIG. 11. In addition, under control of the processing circuit of the touch communications device 501, the touch communications device 501 may use the heartbeats sent from the first touch communications device 520, such as those illustrated in FIG. 11, to check whether the client device such as the first touch communications device 520 is still connected. For brevity, similar descriptions for this exemplary embodiment are not repeated in detail here.

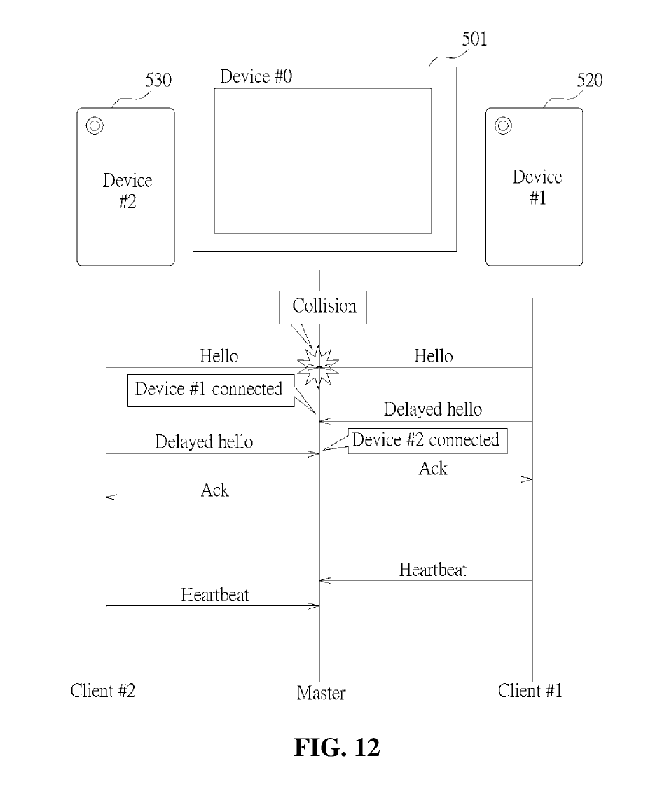

FIG. 12 illustrates some implementation details of the time division control scheme shown in FIG. 11 according to an exemplary embodiment of the present invention. The second touch communications device 530 of this exemplary embodiment can be regarded as the other client device (labeled “Client #2” in FIG. 12 for brevity).

According to this exemplary embodiment, the processing circuit of the touch communications device 501 may interact with any of the touch communications devices 520, 530 and 540, such as the first touch communications device 520 and the second touch communications device 530 in this exemplary embodiment, with aid of time division. For example, under control of the processing circuit of the first touch communications device 520, the first touch communications device 520 may send a signal labeled “Hello” shown in the right half of FIG. 12. In addition, under control of the processing circuit of the second touch communications device 530, the second touch communications device 530 may send a signal labeled “Hello” shown in the left half of FIG. 12. As there is the collision between the two signals, no communications connection is successfully established at this moment.

As shown in FIG. 12, the touch communications devices 520 and 530 may respectively re-send the two signals (labeled “Delayed hello” in FIG. 12, for better comprehension). More particularly, the device 520 may send another signal labeled “Delayed hello” in the right half of FIG. 12. In addition, the device 530 may send another signal labeled “Delayed hello” in the left half of FIG. 12. Under control of the processing circuit of the touch communications device 501, the touch communications device 501 may perform communications to establish the communications connection between the device 501 and the 520, and may further perform communications to establish the communications connection between the device 501 and the device 530.

In this exemplary embodiment, the device 520 may send the signal labeled “Delayed hello” in the right half of FIG. 12 in a random manner, where the delay time between this signal and the previous signal sent from the device 520 may correspond to a first random number. In addition, the device 530 may send the signal labeled “Delayed hello” in the left half of FIG. 12 in a random manner, where the delay time between this signal and the previous signal sent from the device 530 may correspond to a second random number. As a result, the client devices such as the devices 520 530 may talk to (or interact with) the master device such as the touch communications device 501 at separate time points. For example, when collision happens, the client devices (e.g. the devices 520 and s530 in this exemplary embodiment) cannot get Ack from the master device, and the client devices may retry (e.g. send the other signal labeled “Delayed hello” in the right half of FIG. 12, and/or send the other signal labeled “Delayed hello” in the left half of FIG. 12) to ask for establishing the communications connections at random time points, respectively. The master device may use the heartbeats sent from the client devices, such as those illustrated in FIG. 12, to check whether the client devices are still connected, respectively. For brevity, similar descriptions for this exemplary embodiment are not repeated in detail here.

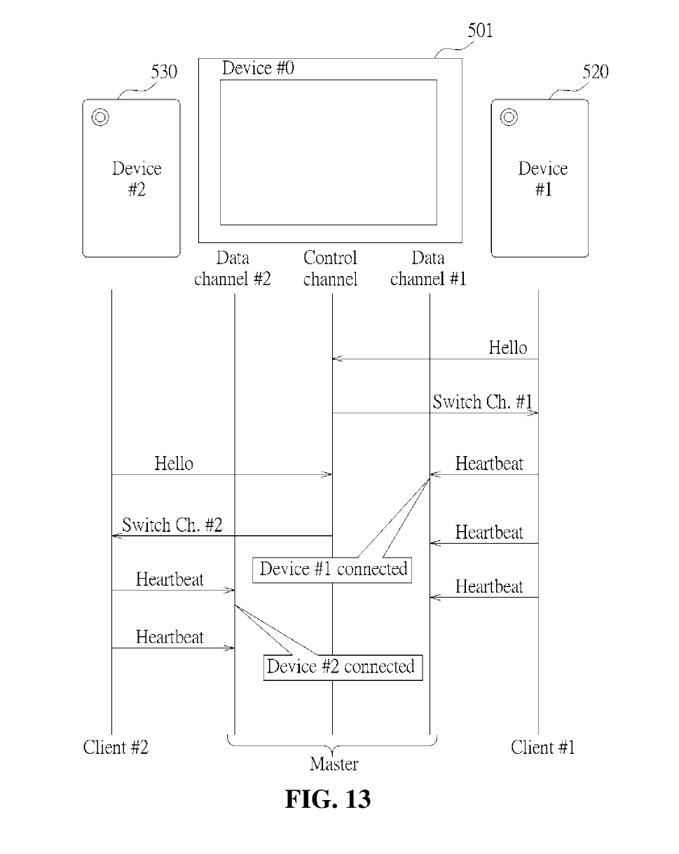

FIG. 13 illustrates a frequency division control scheme involved with the method 600 shown in FIG. 6 according to an exemplary embodiment of the present invention. Please note that the touch communications device 501 of this exemplary embodiment can be regarded as the master device (labeled “Master” in FIG. 13, for brevity), where the first touch communications device 520 and the second touch communications device 530 of this exemplary embodiment can be regarded as the client devices (labeled “Client #1” and “Client #2” in FIG. 13, respectively, for brevity).

According to this exemplary embodiment, the processing circuit of the touch communications device 501 (more particularly, the processing circuit running the program codes mentioned above) may interact with any of the first touch communications device 520, the second touch communications device 530, and the third touch communications device 540, such as the touch communications devices 520 and 530 in this exemplary embodiment, with aid of frequency division. More particularly, the master device such as the device 501 may prepare a plurality of channels corresponding to different frequencies, respectively, to allow the client devices such as the devices 520, 530 and 540 to communicate with the master device through at least one portion of the plurality of channels. For example, a specific channel of the plurality of channels can be defined (and used) as the control channel, and the other channels of the plurality of channels can be defined (and used) as the data channels.

In addition, any of the client devices, such as one of the devices 520 and 530, may initially use the control channel to ask for connecting with the master device. When the master device receives the signal from this client device (e.g. the signal of asking for connecting with the master device), by sending a switch channel request through the control channel, the master device may ask (or instruct) this client device to switch to one of the data channels mentioned above, such as a predetermined data channel corresponding to this client device (e.g. a given data channel). When receiving the switch channel request, this client device may connect to the master device through the predetermined data channel (e.g. a given data channel).

For example, under control of the processing circuit of the device 520, the device 520 may send a signal labeled “Hello” shown in the right half of FIG. 13 through the control channel, to ask for connecting with the touch communications device 501. When the touch communications device 501 receives this signal labeled “Hello”, under control of the processing circuit of the device 501, the device 501 may send the corresponding switch channel request (labeled “Switch Ch. #1” in FIG. 13, for better comprehension) through the control channel, to instruct the device 520 to switch to a given data channel such as the data channel #1. When the device 520 receives this switch channel request (labeled “Switch Ch. #1” in FIG. 13), under control of the processing circuit of the device 520, the device 520 may perform communications to establish the communications connection between the device 520 and the device 501 through the data channel #1.

In another example, under control of the processing circuit of the device 530, the device 530 may send a signal labeled “Hello” shown in the left half of FIG. 13 through the control channel, to ask for connecting with the device 501. When the device 501 receives this signal labeled “Hello”, under control of the processing circuit of the device 501, the device 501 may send the corresponding switch channel request (labeled “Switch Ch. #2” in FIG. 13, for better comprehension) through the control channel, to instruct the device 530 to switch to a given data channel such as the data channel #2. When the device 530 receives this switch channel request (labeled “Switch Ch. #2” in FIG. 13), under control of the processing circuit of the device 530, the device 530 may perform communications to establish the communications connection between the device 530 and the device 501 through the data channel #2.

In this exemplary embodiment, under control of the processing circuit of the device 501, the device 501 may use the heartbeats sent from the device 520, such as those illustrated in the right half of FIG. 13, to check whether the client device such as the device 520 is still connected. In addition, the device 501 may use the heartbeats sent from the device 530, such as those illustrated in the left half of FIG. 13, to check whether the client device such as the device 530 is still connected. For brevity, similar descriptions for this exemplary embodiment are not repeated in detail here.

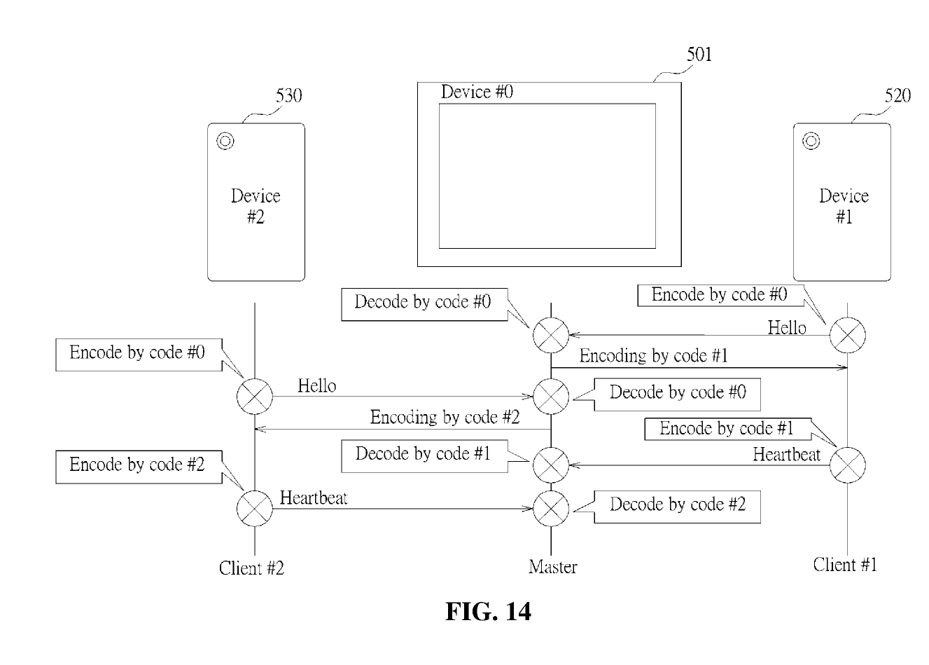

FIG. 14 illustrates a code division control scheme involved with the method 600 shown in FIG. 6 according to an exemplary embodiment of the present invention. Please note that the touch communications device 501 of this exemplary embodiment can be regarded as the master device (labeled “Master” in FIG. 14, for brevity), where the first touch communications device 520 and the second touch communications device 530 of this exemplary embodiment can be regarded as the client devices (labeled “Client #1” and “Client #2” in FIG. 14, respectively, for brevity).

According to this exemplary embodiment, the touch communications device 501 may interact with any of the first touch communications device 520, the second touch communications device 530, and the third touch communications device 540, such as the touch communications devices 520 and 530 in this exemplary embodiment, with aid of code division. More particularly, the master device such as the device 501 may use a plurality of predefined codes for encoding and decoding, to allow the client devices such as the devices 520, 530 and 540 to communicate with the master device such as the device 501 through at least one portion of the plurality of predefined codes. For example, a specific predefined code of the plurality of predefined codes, such as the code #0, can be used to ask for connection, and the other codes of the plurality of predefined codes can be used as the data communications codes.

Any of the client devices, such as one of the devices 520 and 530, may initially use the code for asking for connection mentioned above to ask for connecting with the master device such as the device 501. When the master device receives the signal from this client device (e.g. the signal of asking for connecting with the master device), by sending a switch code request, the master device may ask (or instruct) this client device to switch to one of the data communications codes mentioned above, such as a predetermined data communications code corresponding to this client device (e.g. a given data communications code). When receiving the switch code request, this client device may communicate with the master device through the predetermined data communications code (e.g. a given data communications code). In this exemplary embodiment, when receiving a signal, the master device may try to decode this signal by each of the plurality of predefined codes and may find that one code of the plurality of predefined codes is valid for decoding this signal (e.g. it is successful to decode this signal by using this code), and therefore, the master device can determine that this signal is sent from the client device corresponding to this code. As a result, the master device can know which client device is talking to the master device.

For example, under control of the processing circuit of the device 520, the device 520 may send a signal labeled “Hello” shown in the right half of FIG. 14 through the code for asking for connection such as the code #0, to ask for connecting with the device 501. More particularly, under control of the processing circuit of the device 520, the device 520 may encode this signal by code #0 (labeled “Encode by code #0” in the right half of FIG. 14, for better comprehension). In addition, the device 501 may receive this signal labeled “Hello”, and decode this signal by code #0 (labeled “Decode by code #0” at the uppermost operation in the upper half of FIG. 14, for better comprehension). When the device 501 receives this signal labeled “Hello”, under control of the processing circuit of the device 501, the device 501 may send a corresponding switch code request (labeled “Encoding by code #1” in FIG. 14, for better comprehension) to instruct the device 520 to switch to a given data communications code such as the code #1. When the device 520 receives this switch code request (labeled “Encoding by code #1” in FIG. 14), under control of the processing circuit of the device 520, the device 520 may communicate with the device 501 through the code #1. More particularly, under control of the processing circuit of the device 520, the device 520 may encode information (e.g. heartbeats or data) by code #1 (labeled “Encode by code #1” in FIG. 14, for better comprehension), where under control of the processing circuit of the device 501, the device 501 may decode this information (e.g. heartbeats or data) by code #1 (labeled “Decode by code #1” in FIG. 14, for better comprehension).

In another example, under control of the processing circuit of the second touch communications device 530, the device 530 may send a signal labeled “Hello” shown in the left half of FIG. 14 through the code for asking for connection such as the code #0, to ask for connecting with the device 501. More particularly, under control of the processing circuit of the device 530, the device 530 may encode this signal by code #0 t (labeled “Encode by code #0” in the left half of FIG. 14, for better comprehension). In addition, the device 501 may receive this signal labeled “Hello”, and decodes this signal by code #0 (labeled “Decode by code #0” at the operation next to the uppermost operation in the upper half of FIG. 14, for better comprehension). When the device 501 receives this signal labeled “Hello”, under control of the processing circuit of the device 501, the device 501 may send the corresponding switch code request (labeled “Encoding by code #2” in FIG. 14, for better comprehension), to instruct the device 530 to switch to a given data communications code such as the code #2. When the device 530 receives this switch code request (labeled “Encoding by code #2” in FIG. 14), under control of the processing circuit of the device 530, the device 530 may communicate with the device 501 through the code #2. More particularly, under control of the processing circuit of the device 530, the device 530 may encode information (e.g. heartbeats or data) by code #2 (labeled “Encode by code #2” in FIG. 14, for better comprehension), where under control of the processing circuit of the device 501, the device 501 may decode this information (e.g. heartbeats or data) by code #2 (labeled “Decode by code #2” in FIG. 14, for better comprehension).

In this exemplary embodiment, under control of the processing circuit of the device 501, the device 501 may use the heartbeats sent from the device 520, such as that illustrated in the right half of FIG. 14, to check whether the client device such as the device 520 is still connected. In addition, under control of the processing circuit of the device 501, the device 501 may use the heartbeats sent from the device 530, such as that illustrated in the left half of FIG. 14, to check whether the client device such as the device 530 is still connected. For brevity, similar descriptions for this exemplary embodiment are not repeated in detail here.

In some exemplary embodiments, the processing circuit of a touch communications device may perform touch communications control according to at least one control scheme, wherein the aforementioned at least one control scheme may comprise the strength division control scheme, the time division control scheme, the frequency division control scheme, or the code division control scheme, or may comprise a combination thereof (i.e. a combination of the strength division control scheme, the time division control scheme, the a frequency division control scheme, and/or the code division control scheme).

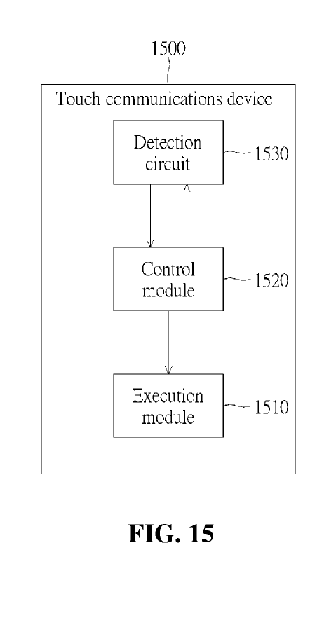

FIG. 15 is a diagram of a touch communications device 1500 according to an exemplary embodiment of the present invention, where the touch communications device 1500 of this exemplary embodiment may comprise at least one portion (e.g. a portion or all) of one of the touch communications device 501, the first touch communications device 520, the second touch communications device 530, and the third touch communications device 540 within the touch communications system 500 shown in FIG. 5.

According to this exemplary embodiment, the touch communications device 1500 may comprise an execution module 1510, a control module 1520, and a detection circuit 1530. In addition, the touch communications device 1500 can be implemented to be a portion of an electronic device such as that mentioned above, where examples of the electronic device may include, but not limited to, Personal Digital Assistants (PDAs), mobile phones, smart phones, laptops (or notebook computer), tablets (or tablet personal computers), gaming devices, electronic books (e-books), computers, televisions (TVs), kiosks, digital photo frames, point of sale (POS) terminals, navigation systems, wearable devices. This is for illustrative purposes only, and is not meant to be a limitation of the present invention. According to some variations of this exemplary embodiment, the touch communications device 1500 can be implemented to be the whole of the electronic device. According to some variations of this exemplary embodiment, the touch communications device 1500 can be integrated into the electronic device.

In this exemplary embodiment, at least some portion of the components shown in FIG. 15, such as one or more of the execution module 1510 and the control module 1520, can be implemented by program modules running on the processing circuit of the touch communications device 1500. This is for illustrative purposes only, and is not meant to be a limitation of the present invention. For example, the processing circuit mentioned above may comprise at least some portion of the components shown in FIG. 15, such as one or more of the execution module 1510 and the control module 1520.

Please note that the touch panel for performing touch communications in this exemplary embodiment (i.e. the touch panel of the touch communications device 1500) can be a movable component or a fixed component within the electronic device. The execution module 1510 can be used for generating a user interface, where the user interface can be generated by running a multimedia application, for example. In addition, the detection circuit 1530 may partially or fully positioned within the touch panel of the touch communications device 1500, and can be used for detecting signals according to the physical proximity between the touch communications device 1500 and another touch communications device. For example, the detection circuit 1530 may comprise a plurality of detection electrodes. According to an exemplary embodiment, the plurality of detection electrodes may comprise at least one of the driving electrodes and sensing electrodes installed on substrates within the touch panel, such as the driving electrodes and the sensing electrodes for forming capacitor structures within the touch panel.

According to an exemplary embodiment of the present invention, the maximum distance between two touch communications devices (which comprise the touch communications device 1500 in this exemplary embodiment) that can successfully communicate with each other can be equal to 2 centimeters (cm). That is, in order to guarantee that the two touch communications devices can successfully communicate with each other, the distance between the two touch communications devices should not be larger than 2 cm in this exemplary embodiment. Thus, the so-called physical proximity between the two touch communications devices (or the physical proximity between the touch panels of the two touch communications devices), or the situation where the touch panel of one of the two touch communications devices is close to the touch panel of the other one of the two touch communications devices, may represent that the distance between the touch panels of the two touch communications devices is not larger than 2 cm in this exemplary embodiment. According to another exemplary embodiment of the present invention, in order to maintain the distance between the touch panels of the two touch communications devices to be not larger than 2 cm, the user may put the two touch communications devices together to allow the touch panels of the two touch communications devices to be in contact with each other. Please note that 2 cm can be taken as an example of the maximum distance between the two touch communications devices that can successfully communicate with each other. This is for illustrative purposes only, and is not meant to be a limitation of the present invention. According to some variations of this exemplary embodiment, the maximum distance between the two touch communications devices that can successfully communicate with each other may vary, depending on various designs of touch panel, touch panel driving IC, and/or electronic device. For example, the maximum distance between the two touch communications devices that can successfully communicate with each other may become greater (e.g. 5 cm, or greater than 5 cm). In another example, the maximum distance between the two touch communications devices that can successfully communicate with each other may become smaller (e.g. 2 millimeter (mm), or less than 2 mm). Besides, the touch panel can be a capacitive touch panel.

The control module 1520 can be coupled to the execution module 1510 and the detection circuit 1530, and can obtain an outline corresponding to the other touch communications device according to the received signal, and determine whether the outline corresponding to the other touch communications device matches a predetermined outline. The control module 1520 can further output a resultant signal to the execution module 1510 according to the determination result (i.e. the determination result of whether the outline corresponding to the other touch communications device matches the predetermined outline). According to the resultant signal, the execution module 1510 can output resultant information corresponding to the other touch communications device mentioned above. In addition, according to the resultant signal, the execution module 1510 can perform an action corresponding to the predetermined outline (or trigger an operation corresponding to the predetermined outline), where examples of this action (or this operation) may include, but not limited to, controlling a device other than the other touch communications device mentioned above, enabling an application, etc.

According to some exemplary embodiments, the operations of controlling the device other than the other touch communications device may vary. For example, when the outline corresponding to the other touch communications device matches the predetermined outline such as a first predetermined outline, the execution module 1510 may control the touch communications device 1500 to turn on a TV and to remotely control the TV to switch to a predetermined channel. In another example, when the outline corresponding to the other touch communications device matches the predetermined outline such as a second predetermined outline, the execution module 1510 may control the touch communications device 1500 to turn on an air condition system. In another example, when the outline corresponding to the other touch communications device matches the predetermined outline such as a third predetermined outline, the execution module 1510 may control the touch communications device 1500 to turn on an audio playback system and to remotely control the audio playback system to play a predetermined audio program. This is for illustrative purposes only, and is not meant to be a limitation of the present invention.

According to some exemplary embodiments, the operations of enabling the application may vary. For example, when the outline corresponding to the other touch communications device matches the predetermined outline such as a first predetermined outline, the execution module 1510 may control the touch communications device 1500 to run an electronic mail (e-mail) application. In another example, when the outline corresponding to the other touch communications device matches the predetermined outline such as a second predetermined outline, the execution module 1510 may control the touch communications device 1500 to run a web page browser application. In another example, when the outline corresponding to the other touch communications device matches the predetermined outline such as a third predetermined outline, the execution module 1510 may control the touch communications device 1500 to run a ticket service application. This is for illustrative purposes only, and is not meant to be a limitation of the present invention.

According to some exemplary embodiments, regarding the operations of enabling the application, different predetermined outlines such as a first predetermined outline, a second predetermined outline, and a third predetermined outline may correspond to the same application, but the privilege levels of using the application may be different. For example, all of the first predetermined outline, the second predetermined outline, and the third predetermined outline may correspond to an e-mail application. When the outline corresponding to the other touch communications device matches the first predetermined outline, the execution module 1510 may control the touch communications device 1500 to run the e-mail application and to allow the user to read e-mails. In addition, when the outline corresponding to the other touch communications device matches the second predetermined outline, the execution module 1510 may control the touch communications device 1500 to run the e-mail application and to allow the user to read and delete e-mails. Additionally, when the outline corresponding to the other touch communications device matches the third predetermined outline, the execution module 1510 may control the touch communications device 1500 to run the e-mail application and to allow the user to read, delete, edit and send new e-mails.

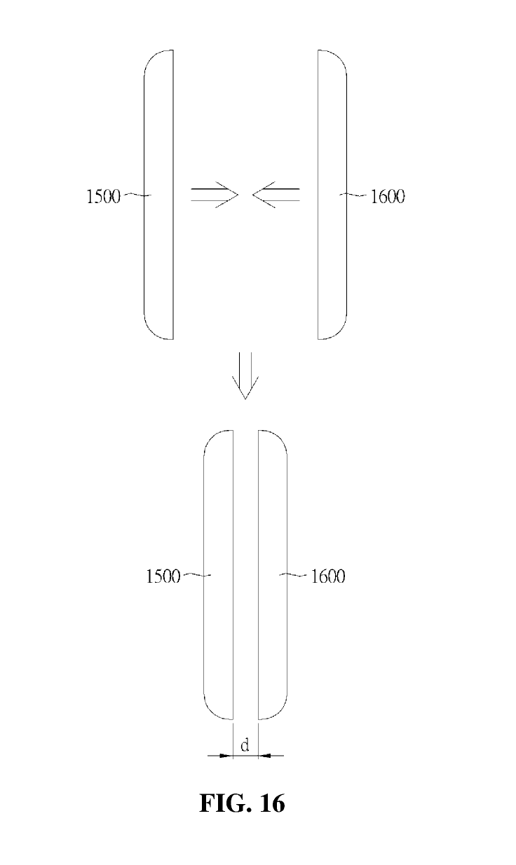

FIG. 16 illustrates two touch communications devices that are put to be close to each other according to an exemplary embodiment of the present invention, where at least one of the two touch communications devices of this exemplary embodiment can be the touch communications device 1500 shown in FIG. 15. For example, the touch communications device 1500 may comprise at least one portion (e.g. a portion or all) of one of the touch communications device 501, the first touch communications device 520, the second touch communications device 530, and the third touch communications device 540 within the touch communications system 500 shown in FIG. 5, where the other one of the two touch communications devices of this exemplary embodiment, i.e. the touch communications device 1600 shown in FIG. 15, may comprise at least one portion (e.g. a portion or all) of another one of the touch communications device 501, the first touch communications device 520, the second touch communications device 530, and the third touch communications device 540 within the touch communications system 500 shown in FIG. 5.

According to this exemplary embodiment, the touch communications device 1500 may comprise a touch panel such as that of the touch communications device 501, and the touch communications device 1600 may comprise a first touch panel such as the touch panel of the first touch communications device 520. The physical proximity between the touch communications device 1500 and the touch communications device 1600 may represent that the distance d between the touch panel of the touch communications device 1500 and the first touch panel of the touch communications device 1600 is not greater than a predetermined length. For example, the predetermined length mentioned above can be equal to 2 cm. This is for illustrative purposes only, and is not meant to be a limitation of the present invention. According to some variations of this exemplary embodiment, the predetermined length mentioned above may be different, depending on various designs of touch panel, touch panel driving IC, and/or electronic device. For example, the predetermined length may become greater (e.g. 5 cm, or greater than 5 cm). In another example, the predetermined length may become smaller (e.g. 2 millimeter (mm), or less than 2 mm). No matter whether the predetermined length is equal to 2 cm or not, when the user(s) place the two touch communications devices to be close to, or in contact with, each other (more particularly, the distance between the touch panels of the two touch communications devices is not greater than the predetermined length, e.g. the distance d between the touch panel of the touch communications device 1500 and the first touch panel of the touch communications device 1600 is not greater than 2 cm), an communications connection between the two touch communications devices can be established with aid of the electric fields between them and the interaction through the electric fields. Please note that the touch communications device 1600 can transmit data to the touch communications device 1500 through the communications connection mentioned above, and the touch communications device 1500 can also transmit data to the touch communications device 1600 through the communications connection mentioned above.

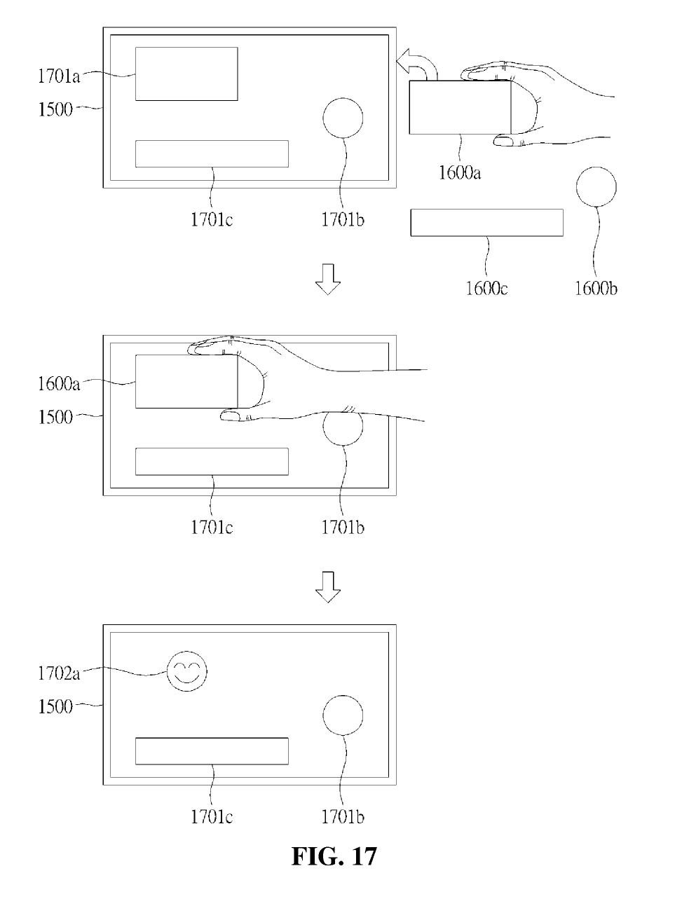

FIG. 17 illustrates a shape detection control scheme involved with the method 600 shown in FIG. 6 according to an exemplary embodiment of the present invention, where the shape detection control scheme can be applied to the touch communications device 1500. As shown in FIG. 17, the user interface may display (or show) a plurality of predetermined outlines such as that mentioned above, which may be different from each other. Examples of the plurality of predetermined outlines may comprise the first predetermined outline 1701a, the second predetermined outline 1701b, and the third predetermined outline 1701c, where the plurality of predetermined outlines may have different shapes, respectively, and/or may have different sizes, respectively. For example, the first predetermined outline 1701a (whose shape may be rectangular) and the second predetermined outline 1701b (whose shape may be circular) have different shapes. In another example, the first predetermined outline 1701a and the third predetermined outline 1701c have the same shape (both are rectangular), but have different sizes. This is for illustrative purposes only, and is not meant to be a limitation of the present invention. According to some variations of this exemplary embodiment, the shapes and/or the sizes may vary, depending on different product designs. According to some variations of this exemplary embodiment, it is unnecessary to display these predetermined outlines 1701a, 1701b, and 1701c within the user interface.

According to this exemplary embodiment, the detection circuit 1530 of the touch communications device 1500 may detect a first signal when the touch communications device 1500 and the touch communications device 1600a (e.g. a rectangular version of the touch communications device 1600) are close to or in contact with each other. In other words, when the touch communications device 1600a is close to, or in contact with, the predetermined outline 1701a displayed by the touch communications device 1500, the touch communications device 1500 and the touch communications device 1600a may establish a communications connection between the touch panel of the touch communications device 1500 and the touch panel of the touch communications device 1600a, where the touch communications device 1600a can transmit the first signal to the touch communications device 1500 through the communications connection mentioned above. According to another exemplary embodiment, the touch communications device 1600a may not transmit the first signal, where the detection circuit 1530 may detect the variations of the capacitance between the electrodes of the touch panel of the touch communications device 1500 due to the touch communications device 1600a (i.e. the capacitance variations caused by the touch communications device 1600a), to obtain the first signal. This is for illustrative purposes only, and is not meant to be a limitation of the present invention.

Please note that the touch communications device 1600a can be taken as an example of the touch communications device 1600. This is for illustrative purposes only, and is not meant to be a limitation of the present invention. The shape and/or the size of the touch communications device under consideration may vary. For example, the touch communications device 1600a can be replaced by a touch communications device 1600b (e.g. a circular version of the touch communications device 1600), where the size and the shape of the touch communications device 1600b may be the same as that of the predetermined outline 1701b. In another example, the touch communications device 1600a can be replaced by a touch communications device 1600c (e.g. a rectangular version of the touch communications device 1600), where the size and the shape of the touch communications device 1600b may be the same as that of the predetermined outline 1701c. In another example, the touch communications device 1600a can be can be replaced by another touch communications device such as a triangle version of the touch communications device 1600, where the size and the shape of the other touch communications device may be the same as that of another predetermined outline such as a triangle outline.

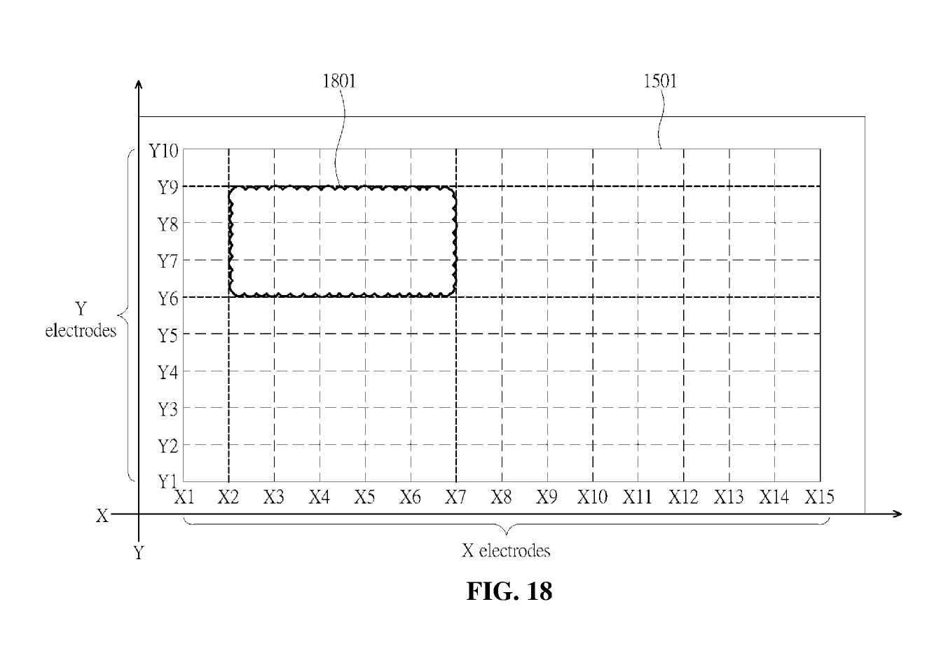

FIG. 18 illustrates a signal sensing control scheme involved with the method 600 shown in FIG. 6 according to an exemplary embodiment of the present invention, where the signal sensing control scheme can be applied to the touch communications device 1500. The touch panel 1501 of the touch communications device 1500 may comprise detection electrodes respectively distributed along the X direction and the Y direction, such as the X electrodes {X1, X2, X3, X4, X5, X6, X7, X8, X9, X10, X11, X12, X13, X14, X15} and the Y electrodes {Y1, Y2, Y3, Y4, Y5, Y6, Y7, Y8, Y9, Y10}, where these detection electrodes can be a portion of the detection circuit 1530. When the touch communications device 1500 is transmitting or receiving signals, these electrodes can be used as transmitting or receiving electrodes. According to an exemplary embodiment, when the touch communications device 1600a is close to, or in contact with, the touch panel 1501, the X electrodes and the Y electrodes corresponding to the location of the touch communications device 1600a may detect the associated capacitance variations. For example, the electrodes X2 through to X7 and the electrodes Y6 through to Y9, or the intersections of these electrodes, may detect the associated capacitance variations, so the detection circuit 1530 may detect the first signal. According to another exemplary embodiment, when the touch communications device 1600a is close to, or in contact with, the touch panel 1501, the touch communications device 1600a may actively transmit signal(s) to the electrodes corresponding to the location of the touch communications device 1600a, such as the electrodes X2 through to X7 and the electrodes Y6 through to Y9, so the detection circuit 1530 may detect a first signal such as that mentioned above. Based on the first signal, the control module 1520 can determine that, within the electrodes of the touch panel 1501, the electrodes X2, X7, Y6, and Y9 may be the boundary electrodes (e.g. those enclosing the area where the touch communications device 1600a covers), and therefore obtain the location and the outline of the touch communications device 1600a. As shown in FIG. 18, the outline 1801 can be taken as an example of the outline of the touch communications device 1600a. In addition, the electrodes shown in FIG. 18 are grid-distributed. This is for illustrative purposes only, and is not meant to be a limitation of the present invention. According to some variations of this exemplary embodiment, the distribution of the electrodes may vary, depending on different design requirements. For example, the distribution of the electrodes may correspond to a direction of 45 degrees with respect to a specific reference direction, where partial outlines corresponding to a direction that is not any of the X direction or the Y direction can be detected. In another example, the electrodes may be arc-shaped electrodes, where partial outlines corresponding to a direction that is not any of the X direction or the Y direction can be detected.

The method that the control module 1520 determines whether the outline of the touch communications device 1600a matches the first predetermined outline 1701a may comprise determining whether the shape of the outline of the touch communications device 1600a is the same as that of the first predetermined outline 1701a and determining whether the difference between the size of the outline of the touch communications device 1600a and the size of the first predetermined outline 1701a is not greater than a predetermined value (e.g. 5% of the size of the first predetermined outline 1701a). When the control module 1520 determines that the outline of the touch communications device 1600a matches the first predetermined outline 1701a, the control module 1520 can output a first resultant signal to the execution module 1510. After the execution module 1510 receives the first resultant signal, the execution module 1510 can output first resultant information corresponding to the touch communications device 1600a according to the first resultant signal, where the first resultant information can be a multimedia file, an audio signal, or any information that is capable of notifying the user of whether the outline of the touch communications device 1600a matches the first predetermined outline 1701a. For example, the touch communications device 1500 may use the display module thereof (more particularly, a touch-sensitive display module such as that mentioned above, or a touch screen such as that mentioned above) to display a smiling face 1702a, or use an audio playback module thereof (e.g. a speaker) to play a predetermined audio file of a hail, or use any other method, to notifying the user of the detection result that the touch communications device 1600a matches the first predetermined outline 1701a.

According to an exemplary embodiment, the control module 1520 may comprise a database arranged for storing the plurality of predetermined outlines mentioned above, such as the first predetermined outline 1701a, the second predetermined outline 1701b, and the third predetermined outline 1701c. This is for illustrative purposes only, and is not meant to be a limitation of the present invention. For example, the plurality of predetermined outlines may be stored in any other space that the control module 1520 can access, may be stored in any form other than database, or even may be generated before comparing with the detected outline of an object, rather than being stored in advance. In another example, the predetermined outlines 1701a, 1701b and 1701c may not be displayed on the user interface, where when the touch communications device 1500 and another touch communications device such as the touch communications device 1600a are close to or in contact with each other and the first signal is detected, the control module 1520 can directly determine whether the first signal complies with any predetermined outline within the plurality of predetermined outlines, and perform the subsequent operations.

According to another exemplary embodiment, the predetermined outlines 1701a and 1701b may correspond to different applications, respectively. More particularly, in this exemplary embodiment, the predetermined outline 1701a may correspond to a multimedia playback application, and the predetermined outline 1701b may correspond to a document file database that can be opened by using a document file database management application. For example, when the control module 1520 determines that the outline of the other touch communications device such as the touch communications device 1600a matches the predetermined outline 1701a and therefore sends a first resultant signal such as that mentioned above to the execution module 1510, the execution module 1510 may enable the multimedia playback application corresponding to the predetermined outline 1701a. In another example, when the control module 1520 determines that the outline of the other touch communications device such as the touch communications device 1600b matches the predetermined outline 1701b and therefore sends a second resultant signal to the execution module 1510, the execution module 1510 may enable the document file database management application to open the document file database corresponding to the predetermined outline 1701b.

According to some exemplary embodiments of the present invention, when the touch communications device 1500 enables the application corresponding to the predetermined outlines 1701a, 1701b or 1701c, the touch communications devices 1500 and the other touch communications device such as the touch communications device 1600a may exchange information corresponding to this application, where the operation of exchanging the information can be completed by using the control module 1520 to control the detection circuit 1530 and/or the execution module 1510. This is for illustrative purposes only, and is not meant to be a limitation of the present invention. For example, suppose that the first predetermined outline 1701a corresponds to an automated teller machine (or automatic teller machine, ATM) service. When the control module 1520 determines that the outline of the touch communications device 1600a matches the predetermined outline 1701a and sends a first resultant signal such as that mentioned above to the execution module 1510, the execution module 1510 may enable the ATM service, and the touch communications device 1500 may further receive the user's password, the transferee account, the transaction amount, etc. from the touch communications device 1600a, to complete the transaction procedure in a convenient manner for the user. In another example, suppose that the predetermined outline 1701b corresponds to a ticket service. In a situation where the touch communications device 1600b is close to, or in contact with, the touch communications device 1500, when the control module 1520 determines that the outline of the touch communications device 1600b matches the predetermined outline 1701b, the touch communications device 1600b may transmit the user's account, the user's password, etc. to the 1500. After obtaining the user information and the information of the order for the ticket(s), the touch communications device 1500 may transmit the electronic ticket file(s) or the associated QR codes to the touch communications device 1600b. As a result, the user may use the ticket(s) with ease.

According to some exemplary embodiments of the present invention, the predetermined outlines 1701a and 1701b may correspond to the same application, but the privilege levels of using this application may be different. For example, when the control module 1520 determines that the outline of the touch communications device 1600a matches the first predetermined outline 1701a and therefore sends a first resultant signal such as that mentioned above to the execution module 1510, the execution module 1510 may enable a document management application to open a specific document, where the user of the touch communications device 1600a may only authorized to read the specific document, rather than editing the specific document. In another example, when the control module 1520 determines that the outline of the touch communications device 1600b matches the second predetermined outline 1701b and therefore sends a second resultant signal such as that mentioned above to the execution module 1510, the execution module 1510 may enable the document management application to open the specific document, where the user of the touch communications device 1600b may read and edit the specific document.

According to some exemplary embodiments of the present invention, the predetermined outlines 1701a and 1701b may correspond to turning on different devices, respectively. For example, when the control module 1520 determines that the outline of the touch communications device 1600a matches the predetermined outline 1701a and therefore sends a first resultant signal such as that mentioned above to the execution module 1510, the execution module 1510 may turn on the TV. In another example, when the control module 1520 determines that the outline of the touch communications device 1600b matches the predetermined outline 1701b and therefore sends a second resultant signal such as that mentioned above to the execution module 1510, the execution module 1510 may turn on the air condition system.

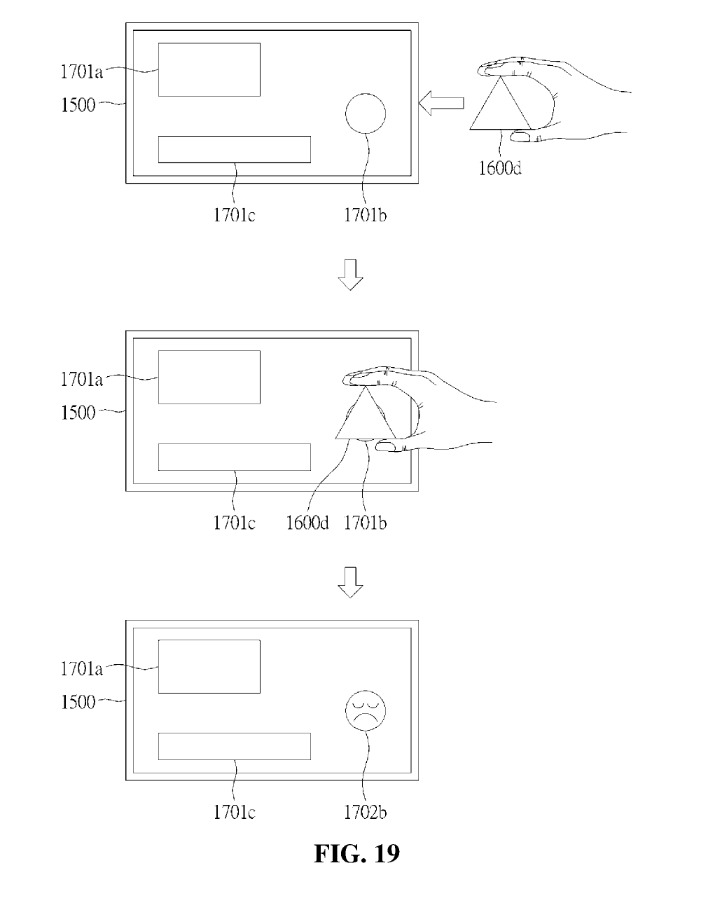

FIG. 19 illustrates a shape detection control scheme involved with the method 600 shown in FIG. 6 according to another exemplary embodiment of the present invention, where the shape detection control scheme can be applied to the touch communications device 1500. As shown in FIG. 19, the touch communications device 1600d may have a triangle shape, and more particularly, can be a triangle version of the touch communications device 1600. When the user places the touch communications device 1600d to be close to, or in contact with, the second predetermined outline 1701b displayed by the touch communications device 1500, a communications connection may be established between the touch communications devices 1500 and 1600d. The touch communications device 1600d may send a second signal to the touch communications device 1500 through the communications connection. According to another exemplary embodiment, the touch communications device 1600d may not transmit the second signal, where the detection circuit 1530 may detect the variations of the capacitance between the electrodes on the touch panel of the touch communications device 1500 due to the touch communications device 1600d (i.e. the capacitance variations caused by the touch communications device 1600d), to obtain the second signal. After receiving the second signal, the control module 1520 can obtain the outline corresponding to the touch communications device 1600d, and more particularly, the shape and the size of the touch communications device 1600d. As shown in FIG. 19, although it seems that the size of the touch communications device 1600d is roughly the same as that of the predetermined outline 1701b, the shape of the touch communications device 1600d (e.g. the triangle shape in this exemplary embodiment) is different from that of the predetermined outline 1701b (e.g. the circular shape in this exemplary embodiment), and therefore, the control module 1520 determines that the outline of the touch communications device 1600d does not match the predetermined outline 1701b, and may send a first resultant signal that indicates the associated detection result, to the execution module 1510. After the execution module 1510 receives this first resultant signal, the execution module 1510 can output first resultant information corresponding to the touch communications device 1600d according to this first resultant signal. For example, the execution module 1510 may use the display module thereof to display a crying face 1702b, or use the audio playback module thereof to play a predetermined audio file of a warning indicating the error, or use any other method, to notifying the user of the detection result that the touch communications device 1600d does not match the predetermined outline 1701b.

According to another exemplary embodiment, when the control module 1520 determines that the outline of the touch communications device 1600d does not match the predetermined outline 1701b and therefore sends this first resultant signal to the execution module 1510, the execution module 1510 may enable a specific application. For example, the specific application can be a warning application. This is for illustrative purposes only, and is not meant to be a limitation of the present invention. In another example, when the control module 1520 determines that the outline of the touch communications device 1600d does not match the predetermined outline 1701b and therefore sends this first resultant signal to the execution module 1510, the execution module 1510 may stop allowing the access to the touch communications device 1500 (more particularly, the access to the data or information in the touch communications device 1500).

According to some exemplary embodiments of the present invention, in a situation where high security level is required (e.g. for applications regarding confidential issues, or navigating or editing confidential files, etc.), the shape detection control schemes described above can be combined with the action trigger control scheme shown in FIG. 7, where an application can be enabled only when all of outlines of multiple devices match corresponding predetermined outlines. For example, when the detection circuit 1530 detects that both of the touch communications devices 1600a and 1600b are close to, or in contact with, the touch communications device 1500, the control module 1520 may determine whether the outline of the touch communications device 1600a and the outline of the touch communications device 1600b respectively match the predetermined outline 1701a and the predetermined outline 1701b, where when it is detected that the outline of the touch communications device 1600a and the outline of the touch communications device 1600b respectively match the predetermined outline 1701a and the predetermined outline 1701b, the execution module 1510 may enable an application regarding confidential issues, or allow the access to confidential information stored in the touch communications device 1500.

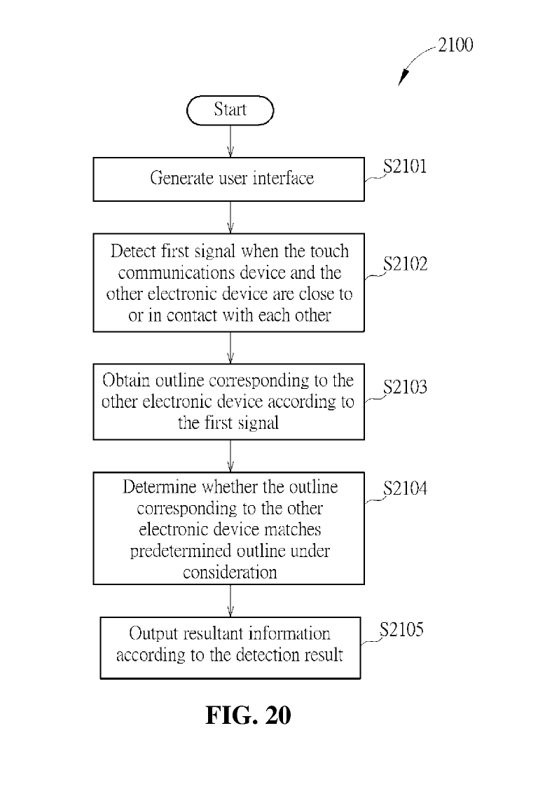

Please refer to FIGS. 15-20. FIG. 20 illustrates a working flow 2100 involved with the method 600 shown in FIG. 6 according to an exemplary embodiment of the present invention, where the working flow 2100 can be applied to the touch communications devices 501 shown in FIG. 5, the touch communications device 1500 shown in FIG. 15, etc.

Take the touch communications device 1500 for example, in Step S2101, the execution module 1510 may generate a user interface such as that mentioned above, where the user interface may display (or show) one or more predetermined outlines such as the plurality of predetermined outlines mentioned above. For example, the plurality of predetermined outlines may respectively have different shapes and/or different sizes. In this exemplary embodiment, the touch communications device 1500 may comprise a database such as that mentioned above, for storing the plurality of predetermined outlines (e.g. the predetermined outlines 1701a, 1701b and 1701c). This is for illustrative purposes only, and is not meant to be a limitation of the present invention. According to some variations of this exemplary embodiment, as long as the control module 1520 can determine whether the outline of the other electronic device such as the touch communications device 1600 (e.g. one of the touch communications devices 1600a, 1600b, and 1600c) matches the predetermined outline under consideration, it is not necessary to use the database to store the plurality of predetermined outlines. For example, the plurality of predetermined outlines can be store in other space or in forms other than database or can even be generated in real time, rather than being stored in advance. In another example, the aforementioned one or more predetermined outlines may not be displayed.

In Step S2102, the detection circuit 1530 may detect a first signal such as that mentioned above when the touch communications device 1500 and the other electronic device such as the touch communications device 1600 are close to or in contact with each other and a communications connection is established between the touch communications devices 1500 and 1600. In this exemplary embodiment, the touch communications device 1600 may send the first signal to the device 150 through the communications connection. This is for illustrative purposes only, and is not meant to be a limitation of the present invention. According to another exemplary embodiment, the touch communications device 1600a may not transmit the first signal, where the detection circuit 1530 may detect the variations of the capacitance between the electrodes of the touch panel of the touch communications device 1500 due to the touch communications device 1600 (i.e. the capacitance variations caused by the touch communications device 1600), to obtain the first signal. Please note that the touch communications devices 1500 and 1600 are close to or in contact with each other may represent that the distance between the touch panel of the touch communications device 1500 and the touch panel of the touch communications device 1600 is not greater than a predetermined length such as that mentioned above (e.g. 2 cm).

In Step S2103, the control module 1520 may obtain the outline corresponding to the other electronic device such as the touch communications device 1600 according to the first signal.

In Step S2104, the control module 1520 may determine whether the outline corresponding to the other electronic device such as the touch communications device 1600 matches the predetermined outline under consideration.

In Step S2105, the touch communications device 1500 may output resultant information such as that mentioned above according to the detection result of Step S2104, i.e. the detection result of whether the outline of the touch communications device 1600 matches the predetermined outline under consideration. More particularly, the control module 1520 may output a first resultant signal such as that mentioned above to the execution module 1510 according to the detection result, and the execution module 1510 may output first resultant information such as that mentioned above according to the first resultant signal, where the first resultant information can be a multimedia file, an audio signal, or any information that is capable of notifying the user of whether the outline of the touch communications device 1600 matches the predetermined outline under consideration. For example, when the control module 1520 determines that the outline of the touch communications device 1600 matches the predetermined outline under consideration, the touch communications device 1500 may use the display module thereof to display a smiling face, or use the audio playback module thereof to play the predetermined audio file of a hail, or use any other method, to notifying the user of the detection result that the touch communications device 1600 matches this predetermined outline. In another example, when the control module 1520 determines that the outline of the touch communications device 1600 does not match this predetermined outline, the touch communications device 1500 may use the display module thereof to display a crying face, or use the audio playback module thereof to play the predetermined audio file of the warning indicating the error, to notifying the user of the detection result that the touch communications device 1600 does not match this predetermined outline.

As shown in FIG. 20, the operations of Step S2101 through to S2105 are illustrated for better comprehension. This is for illustrative purposes only, and is not meant to be a limitation of the present invention. According to some variations of this exemplary embodiment, the operations of the working flow 2100 may vary, depending on different designs. For example, one or more steps within the working flow 2100 may be omitted. In another example, one or more steps may be added into the working flow 2100. In another example, the order of performing the operations of Step S2101 through to S2105 may be changed. For example, the Steps 2101 and 2105 may be omitted. In another example, a step of performing an action corresponding to this predetermined outline can be added after Step 2104. In still another example, the Step 2105 can be replaced by performing an action corresponding to this predetermined outline.

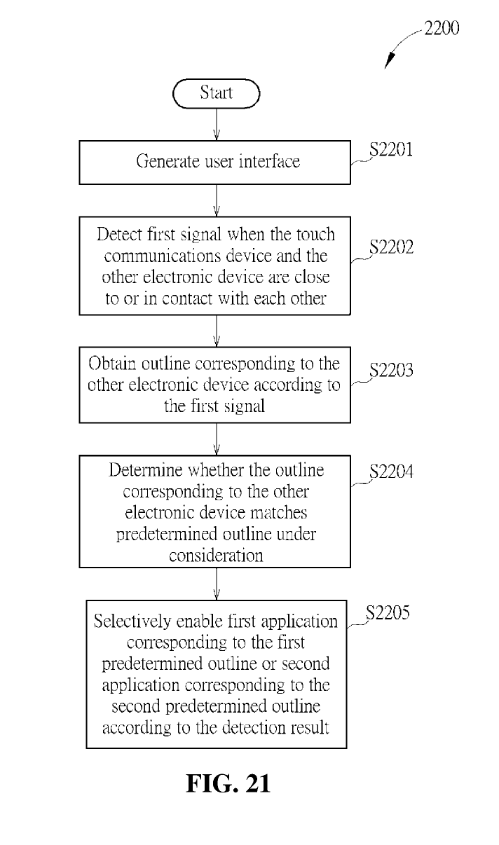

Please refer to FIGS. 15-19 and FIG. 21. FIG. 21 illustrates a working flow 2200 involved with the method 600 shown in FIG. 6 according to another exemplary embodiment of the present invention. The operations of Step S2201 through to Step S2204 can be the similar to that of Step S2101 through to Step S2104 of the working flow 2100 shown in FIG. 20, respectively, where the user interface may display (or show) the plurality of predetermined outlines mentioned above, such as the first predetermined outline 1701a and the second predetermined outline 1701b that are different from each other.

According to this exemplary embodiment, the first predetermined outline 1701a and the second predetermined outline 1701b may respectively correspond to different applications. More particularly, in this exemplary embodiment, the predetermined outline 1701a may correspond to a multimedia playback application such as that mentioned above, and the predetermined outline 1701b may correspond to a document file database such as that mentioned above, which can be opened by using a document file database management application such as that mentioned above.

In Step S2205, the touch communications device 1500 may selectively enable a first application (e.g. the multimedia playback application) corresponding to the predetermined outline 1701a or a second application corresponding to the predetermined outline 1701b according to the detection result of Step S2104, i.e. the detection result of whether the outline of the touch communications device 1600 (e.g. one of the touch communications devices 1600a, 1600b, and 1600c) matches the predetermined outline under consideration. For example, when the control module 1520 determines that the outline of the other touch communications device such as the touch communications device 1600a matches the predetermined outline 1701a and therefore sends a first resultant signal such as that mentioned above to the execution module 1510, the execution module 1510 may enable the multimedia playback application corresponding to the predetermined outline 1701a. In another example, when the control module 1520 determines that the outline of the other touch communications device such as the touch communications device 1600b matches the predetermined outline 1701b and therefore sends a second resultant signal such as that mentioned above to the execution module 1510, the execution module 1510 may enable the document file database management application to open the document file database corresponding to the predetermined outline 1701b. In another example, when the control module 1520 determines that the outline of the other touch communications device such as the touch communications device 1600d does not match any predetermined outline, the execution module 1510 may enable a specific application such as that mentioned above (e.g. the warning application), or may stop allowing the access to the touch communications device 1500 (for example, the access to the data or information in the touch communications device 1500).

Please note that for the exemplary embodiments shown in FIGS. 5-9, the identification information of a specific touch communications device of the plurality of touch communications devices can be obtained by performing above illustrated shape detection on the specific touch communications device. The above mentioned detection result indicating whether an outline of a specific touch communications device matches a predetermined outline can be used as the identification information of the specific touch communications device for the exemplary embodiments shown in FIGS. 5-9. In some exemplary embodiments, the identification information of the specific touch communications device can be obtained by detecting whether a shape and a size of the outline of the specific touch communications device match that of the predetermined outline, respectively. Please note that, in some exemplary embodiments, the touch communications device 1500 may not display the predetermined outlines such as the first predetermined outline 1701a, the second predetermined outline 1701b, and the third predetermined outline 1701c on the user interface. When the touch communications device 1500 and the touch communications device 1600 (e.g. one of the touch communications devices 1600a, 1600b, and 1600c) are close to or in contact with each other and therefore the outline of the touch communications device 1600 is detected, the control module 1520 can determine whether the outline of the touch communications device 1600 matches any predetermined outline within the plurality of predetermined outlines. For example, when it is detected that the outline of the touch communications device 1600 matches a predetermined outline such as that mentioned above, the touch communications device 1500 (more particularly, the control module 1520 thereof) may trigger performing the operation(s) corresponding to the predetermined outline. In addition, the touch communications device 1600 may transmit the identification information thereof (e.g. the user's name, the user's password, the identification number of the touch communications device 1600, or any information that can be used for identifying the touch communications device 1600 or the user of the touch communications device 1600). In this exemplary embodiment, the predetermined outline(s) and the operation(s) corresponding to the predetermined outline(s) may be edited, created, and/or deleted by the user. For brevity, similar descriptions for these exemplary embodiments are not repeated in detail here.

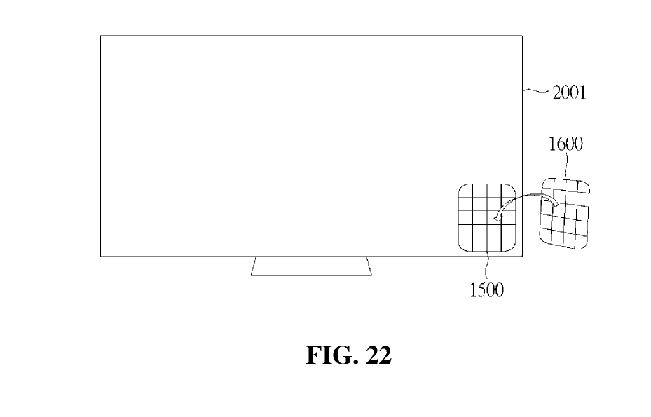

FIG. 22 illustrates an electronic device 2001 according to an exemplary embodiment of the present invention, where any of the touch communications devices mentioned in the exemplary embodiments above, such as the touch communications device 501 or 1500, can be integrated into the electronic device 2001, and any other one of the touch communications devices mentioned in the exemplary embodiments above, such as the touch communications device 520 or 1600, may interact with the electronic device 2001 through the touch communications device that is integrated into the electronic device 2001. As shown in FIG. 22, only a portion of the display module (e.g. a liquid crystal display (LCD) module, or LCM) of the electronic device 2001 is equipped with the touch-sensitive function. Thus cost of the electronic device 2001 can be reduced. In a situation where the touch communications device 1500 is integrated into the electronic device 2001, a communications connection may be established between the touch communications device 1500 and the touch communications device 1600, thus data can be transmitted between the touch communications devices 1500 and 1600. According to this exemplary embodiment, the electronic device 2001 can be a monitor. This is for illustrative purposes only, and is not meant to be a limitation of the present invention. According to some variations of this exemplary embodiment, the electronic device 2001 shown in FIG. 22 can be any other device. For example, the electronic device 2001 can be a TV, a refrigerator, etc.

In one or more of the embodiments respectively shown in FIGS. 5-22, information regarding the region(s) on the touch panel of the main touch communications device (e.g. the touch communications device 501) for placing other touch communications device(s) to be close to, or in contract with, the main touch communications device, such as text string(s) or user name(s) or the border lines of the region(s), may be displayed. This is for illustrative purposes only, and is not meant to be a limitation of the present invention. According to some embodiments of the present invention, it is unnecessary to display the aforementioned information regarding the region(s) on the touch panel of the main touch communications device. For example, as long as communications connection(s) between the main touch communications device and other touch communications device(s) can be established (e.g. through a portion of the main touch communications device, the main touch communications device may be triggered to perform the predetermined action mentioned above.

Those skilled in the art will readily observe that numerous modifications and alterations of the device and method may be made while retaining the teachings of the invention. Accordingly, the above disclosure should be construed as limited only by the metes and bounds of the appended claims.

1. A method for performing touch communications control, the method being applied to a touch communications device, the method comprising the steps of:
performing communications to establish at least one communications connection between the touch communications device and a plurality of touch communications devices;
obtaining identification information of each touch communications device of the plurality of touch communications devices to determine whether each touch communications device of the plurality of touch communications devices is one of a plurality of predetermined touch communications devices; and
performing a predetermined action based on whether each touch communications device of the plurality of touch communications devices is one of the plurality of predetermined touch communications devices.

2. The method of claim 1, wherein the step of obtaining the identification information of each touch communications device of the plurality of touch communications devices to determine whether each touch communications device of the plurality of touch communications devices is one of the plurality of predetermined touch communications devices further comprises:
obtaining the identification information of a specific touch communications device of the plurality of touch communications devices through the communications connection between the touch communications device and the specific touch communications device; and
determining whether the specific touch communications device is one of the plurality of predetermined touch communications devices according to the identification information of the specific touch communications device.

3. The method of claim 1, wherein the step of performing the predetermined action based on whether each touch communications device of the plurality of touch communications devices is one of the plurality of predetermined touch communications devices further comprises:
performing the predetermined action when it is detected that each touch communications device of the plurality of touch communications devices is one of the plurality of predetermined touch communications devices, wherein the predetermined action is associated with the plurality of touch communications devices.

4. The method of claim 1, wherein the step of performing the predetermined action based on whether each touch communications device of the plurality of touch communications devices is one of the plurality of predetermined touch communications devices further comprises:
when it is detected that each touch communications device of the plurality of touch communications devices is one of the plurality of predetermined touch communications devices, waiting for a predetermined time period and checking whether the communications connection between the touch communications device and any touch communications device of the plurality of touch communications devices is broken; and
performing the predetermined action when it is detected that the communications connection between the touch communications device and any touch communications device of the plurality of touch communications devices is not broken during the predetermined time period, wherein the predetermined action is associated with the plurality of touch communications devices.

5. The method of claim 1, wherein the touch communications device and the plurality of touch communications devices are implemented with touch communications technologies.

6. The method of claim 1, wherein before the communications connection between the touch communications device and a specific touch communications device of the plurality of touch communications devices is established, a distance between a touch panel of the specific touch communications device and a touch panel of the touch communications device is not larger than a predetermined length.

7. The method of claim 1, further comprising:
performing touch communications control according to at least one control scheme, wherein the at least one control scheme comprises a strength division control scheme, a time division control scheme, a frequency division control scheme, a code division control scheme or a combination thereof.

8. The method of claim 1, wherein the step of obtaining the identification information of each touch communications device of the plurality of touch communications devices to determine whether each touch communications device of the plurality of touch communications devices is one of the plurality of predetermined touch communications devices further comprises:
obtaining the identification information of a specific touch communications device of the plurality of touch communications devices by performing shape detection on the specific touch communications device.

9. The method of claim 8, wherein the identification information of the specific touch communications device is a detection result indicating whether an outline of the specific touch communications device matches a predetermined outline.

10. The method of claim 9, further comprising:
detecting whether a shape and a size of the outline of the specific touch communications device match that of the predetermined outline, respectively, to obtain the identification information of the specific touch communications device.

11. An apparatus for performing touch communications control, the apparatus comprising at least one portion of a touch communications device, the apparatus comprising:
a touch panel arranged to allow at least one communications connection to be established through the touch panel; and
a processing circuit, coupled to the touch panel, arranged to perform touch communications control, wherein with aid of the touch panel, the processing circuit performs communications to establish at least one communications connection between the touch communications device and a plurality of touch communications devices, obtains identification information of each touch communications device of the plurality of touch communications devices to determine whether each touch communications device of the plurality of touch communications devices is one of a plurality of predetermined touch communications devices, and performs a predetermined action based on whether each touch communications device of the plurality of touch communications devices is one of the plurality of predetermined touch communications devices.

12. The apparatus of claim 11, wherein the processing circuit obtains the identification information of a specific touch communications device of the plurality of touch communications devices through the communications connection between the touch communications device and the specific touch communications device; and the processing circuit determines whether the specific touch communications device is one of the plurality of predetermined touch communications devices according to the identification information of the specific touch communications device.

13. The apparatus of claim 11, wherein the processing circuit performs the predetermined action when it is detected that each touch communications device of the plurality of touch communications devices is one of the plurality of predetermined touch communications devices, wherein the predetermined action is associated with the plurality of touch communications devices.

14. The apparatus of claim 11, wherein when it is detected that each touch communications device of the plurality of touch communications devices is one of the plurality of predetermined touch communications devices, the processing circuit waits for a predetermined time period and checks whether the communications connection between the touch communications device and any touch communications device of the plurality of touch communications devices is broken; and the processing circuit performs the predetermined action when it is detected that the communications connection between the touch communications device and any touch communications device of the plurality of touch communications devices is not broken during the predetermined time period, wherein the predetermined action is associated with the plurality of touch communications devices.

15. The apparatus of claim 11, wherein the touch communications device and the plurality of touch communications devices are implemented with touch communications technologies.

16. The apparatus of claim 11, wherein before the communications connection between the touch communications device and a specific touch communications device of the plurality of touch communications devices is established, a distance between a touch panel of the specific touch communications device and the touch panel of the touch communications device is not larger than a predetermined length.

17. The apparatus of claim 11, wherein the processing circuit performs touch communications control according to at least one control scheme, wherein the at least one control scheme comprises a strength division control scheme, a time division control scheme, a frequency division control scheme, a code division control scheme or a combination thereof.

18. The apparatus of claim 11, wherein the processing circuit obtains the identification information of a specific touch communications device of the plurality of touch communications devices by performing shape detection on the specific touch communications device.

19. The apparatus of claim 18, wherein the identification information of the specific touch communications device is a detection result indicating whether an outline of the specific touch communications device matches a predetermined outline.

20. The apparatus of claim 19, wherein the processing circuit detects whether a shape and a size of the outline of the specific touch communications device match that of the predetermined outline, respectively, to obtain the identification information of the specific touch communications device.

21. An electronic device, comprising a sub-region, wherein the sub-region comprises the apparatus of claim 11.
